(19) United States
(12) Patent Application Publication
(10) Pub. No.: US 2020/0290905 A1
(43) Pub. Date: Sep. 17, 2020

(54) COMPOUND DISPENSER

(71) Applicant: Ross David DETTORRE, Chino Hills, CA (US)

(72) Inventor: Ross David DETTORRE, Chino Hills, CA (US)

(21) Appl. No.: 16/816,388

(22) Filed: Mar. 12, 2020

Related U.S. Application Data
(60) Provisional application No. 62/919,486, filed on Mar. 13, 2019.

(51) Int. Cl. C02F 1/68; C02F 1/76

(52) U.S. Cl. CPC C02F 1/687; C02F 2103/42; C02F 1/76

(57) ABSTRACT

A device for dispensing a compound that has a side opening for side loading the compound. The side opening is defined by alignment of a first opening and a second opening of respective first and second members of the device.

### CROSS-REFERENCE TO RELATED APPLICATIONS

This application claims the benefit of priority of co-pending U.S. Utility Provisional Patent Application 62/919,486, filed 13 Mar. 2019, the entire disclosure of which is expressly incorporated by reference in its entirety herein.

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

### Field of the Invention

One or more embodiments of the present invention relate to a dispenser and more particularly, to a compound dispenser that may accommodate a chemical compound, and when in an enclosed body of water, the chemical compound dissolves into the body of water.

### Description of Related Art

Conventional floating chlorine dispensers are well known and have been in use for a number of years. Regrettably, most conventional floating chlorine dispensers are complex to manufacture, have too many parts, are bulky, very difficult to operate, and inefficiently disperse dissolved chlorine tablets.

A drawback with most conventional floating chlorine dispensers is that the bulk of their body float above water during use. This means that the parts that are floating above water are under intense sunlight and reflections thereof from water. The impingement of the rays of the sunlight and its reflections on the floating chlorine dispenser generate heat in the interior, causing the chlorine tablet therein to deplete quicker (while in the dispenser)—hence making less efficient use of the tablet.

Another major drawback with most conventional floating chlorine dispensers is the lack of proper flow of water through them to melt and disperse chlorine tablets into water. The extremely restricted water flow in or out of dispenser tends to keep water flown inside substantially stagnant within the dispensers, which heats up for the reasons mentioned above, further accelerating the depletion of chlorine tablets within dispensers.

Unfortunately, the minimal amount of chlorine that is eventually released from the bottom of the dispensers, is so minuscule that regrettably, heat and ultraviolet rays from the sun impinging on water may easily and quickly neutralize the small amounts of dispersed chlorine, making the use of most conventional floating chlorine dispensers useless and completely wasteful.

Another drawback with conventional floating chlorine dispensers is the problem of difficulty to operate the many parts, which is compounded as its many parts continue to deteriorate under ultraviolet sunlight (and reflections thereof from water). For example, most conventional floating chlorine dispensers have a cap that must be removed to insert chlorine tablets and closed thereafter before use, adding unnecessary and cumbersome steps in using the floating dispenser.

Another drawback with most conventional floating chlorine dispensers is a lack of a proper indicator (if any) for depleted chlorine tablets. For example, with most conventional floating chlorine dispensers, it would not be possible to determine within any reasonable accuracy by an observer if any chlorine tablets still remain or have dissolved and should be replenished.

A further drawback with most conventional floating chlorine dispensers is that since most freely float on water, they tend to be force-pulled towards the recycling intake of the pool water pump. The pull of water into the intake of the pool pump causes the dispensers to be drawn towards the intake and float above it at the same location for as long as the pool pump operates. Regrettably however, when dispensers remain in position above the intake, high concentration of dispersed chlorine is directly pulled and vacuumed into the pool pump. In most cases, the high concentrations of dissolved chlorine directly sucked into the pool pump motor may damage the motor bearings.

Still a further drawback with most conventional floating chlorine dispensers is that since most freely float on water, if pool pump is OFF, they may float towards the steps of the pool and become stuck on one of the pool steps. As they linger on the pool step, the high concentrations of dissolved chlorine come into contact with top step surface, damaging the step paint or other material.

Yet a further drawback with most conventional floating chlorine dispensers is that they are manufactured in various sizes commensurate with closed bodies of water within which they are to be used. For example, larger sized floating chlorine dispensers may be used in pools whereas smaller sized versions may be used in smaller pools such as a spa. This means that different sized floating chlorine dispensers must be bought for different sized pools.

Accordingly, in light of the current state of the art and the drawbacks to current floating chlorine dispensers mentioned above, a need exists for a compound dispenser that would not be bulky but have a compact form-factor, the size of which may be varied by users.

Further, a need exists for a compound dispenser that would be simple to manufacture, with minimal parts, and easy to operate.

Still further, a need exists for a compound dispenser that would include an integral structure that when used, would restrict movement and maintain the compound dispenser within a certain area.

Yet further, a need exists for a compound dispenser that would provide a clear indication to replenish the substantially depleted compound.

Additionally, a need exists for a compound dispenser that would efficiently disperse the dissolved compound into water.

### BRIEF SUMMARY OF THE INVENTION

A non-limiting, exemplary aspect of an embodiment of the present invention provides a device for dispensing a compound, comprising

a first member that includes a first opening on a side of the first member;

a second member that includes a second opening on a side of the second member;

wherein: the first opening and the second opening when aligned define a side opening of the device;

wherein: the compound is side loaded through the side opening of the device.

Another non-limiting, exemplary aspect of an embodiment of the present invention provides a device for dispensing a compound, comprising

a cap;

a first member, with the cap detachably associated with the first member;

a second member moveably associated with the first member;

the first and the second members define a side opening of the device that varies in size as the first and the second members move;

wherein: the compound is side loaded into the device without removing the cap through the side opening or top-loaded by removing the cap.

Still another non-limiting, exemplary aspect of an embodiment of the present invention provides a device for dispensing a compound, comprising

a cap;

a floatation element removably associated with the cap;

a first member, with the cap detachably associated with the first member;

a second member moveably associated with the first member,

the first and the second members define a side opening of the device that varies in size as the first and the second members move;

wherein: the compound is side loaded into the device without removing the cap through the side opening or top-loaded by removing the cap.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1C are non-limiting, exemplary illustrations of a compound dispenser device in accordance with one or more embodiments of the present invention;

FIGS. 2A to 2J are non-limiting, exemplary illustrations of the various views of the compound dispenser device shown in FIGS. 1A to 1C, but in a fully retracted, stored state in accordance with one or more embodiments of the present invention;

FIGS. 3A and 3B are non-limiting, exemplary illustrations of the various views of the compound dispenser device shown in FIGS. 1A to 2J, progressively illustrating a removal of the retainer band in accordance with one or more embodiments of the invention; FIGS. 3C and 3D illustrate details of the connecting structure of the retainer band in accordance with one or more embodiments of the present invention;

FIGS. 4A to 4C are non-limiting, exemplary illustrations of the lateral views of the compound dispenser device shown in FIGS. 1A to 3D, in a fully retracted, collapsed position with retainer band removed in accordance with one or more embodiments of the present invention;

FIGS. 5A to 5I are non-limiting, exemplary illustrations of the compound dispenser device shown in FIGS. 1A to 4C in a fully extended (or protracted) position in accordance with one or more embodiments of the present invention;

FIGS. 6A to 6C are non-limiting, exemplary illustrations of various sectional views of the compound dispenser device shown in FIGS. 1A to 5I in accordance with one or more embodiments of the present invention;

FIG. 7 is a non-limiting exemplary exploded view illustration of the various components of the compound dispenser device shown in FIGS. 1A to 6C in accordance with one or more embodiments of the present invention;

FIGS. 8A to 8K are non-limiting, exemplary illustrations of the various views of a cap of the compound dispenser device shown in FIGS. 1A to 7, including one or more floatation elements in accordance with one or more embodiments of the present invention;

FIGS. 9A to 9G are non-limiting, exemplary illustrations of the various views of a first member of the compound dispenser device shown in FIGS. 1A to 8K in accordance with one or more embodiments of the present invention;

FIGS. 10A to 10J are non-limiting, exemplary illustrations of the various views of a second member of the compound dispenser device shown in FIGS. 1A to 9G in accordance with one or more embodiments of the present invention;

FIGS. 11A-1 to 11H-2 are non-limiting, exemplary illustrations of the various views of the compound dispenser device shown in FIGS. 1A to 10J, progressively illustrating the working cooperative relationship between various openings as first and second members are rotated when compound dispenser device is in a fully extended (or protracted) position in accordance with one or more embodiments of the present invention;

FIGS. 12A to 12O are non-limiting, exemplary illustrations of a compound dispenser device shown in FIGS. 1A to 11H-2, with an added holder for anti-electrolysis anode element in accordance with another embodiment of the present invention; and

FIGS. 13A to 13C are non-limiting, exemplary illustrations of a compound dispenser device shown in FIGS. 1A to 12O, with an added well known, conventional lantern for lighting and aesthetics in accordance with another embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention provide a compound dispenser that is not bulky but has a compact form-factor, the size of which may be varied by users.

One or more embodiments of the present invention provide a compound dispenser that is simple to manufacture, with minimal parts, and easy to operate.

One or more embodiments of the present invention provide a compound dispenser that includes an integral structure that, when used, restricts movement and maintains the compound dispenser within a certain area.

One or more embodiments of the present invention provide a compound dispenser that provides a clear indication to replenish the substantially depleted compound.

One or more embodiments of the present invention provide a compound dispenser that efficiently disperses the dissolved compound into water.

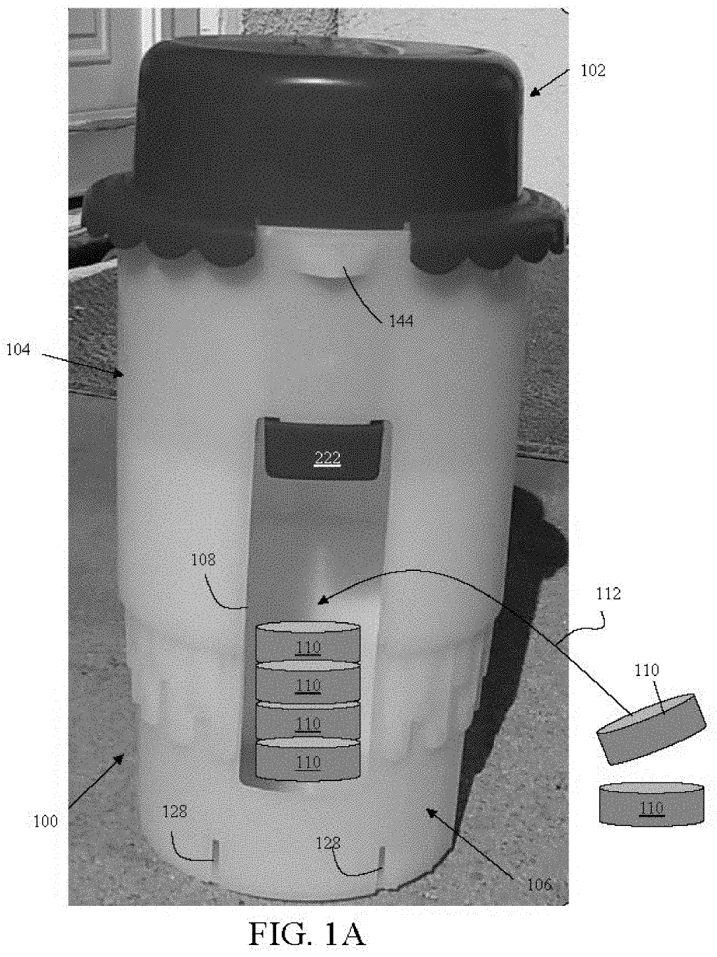

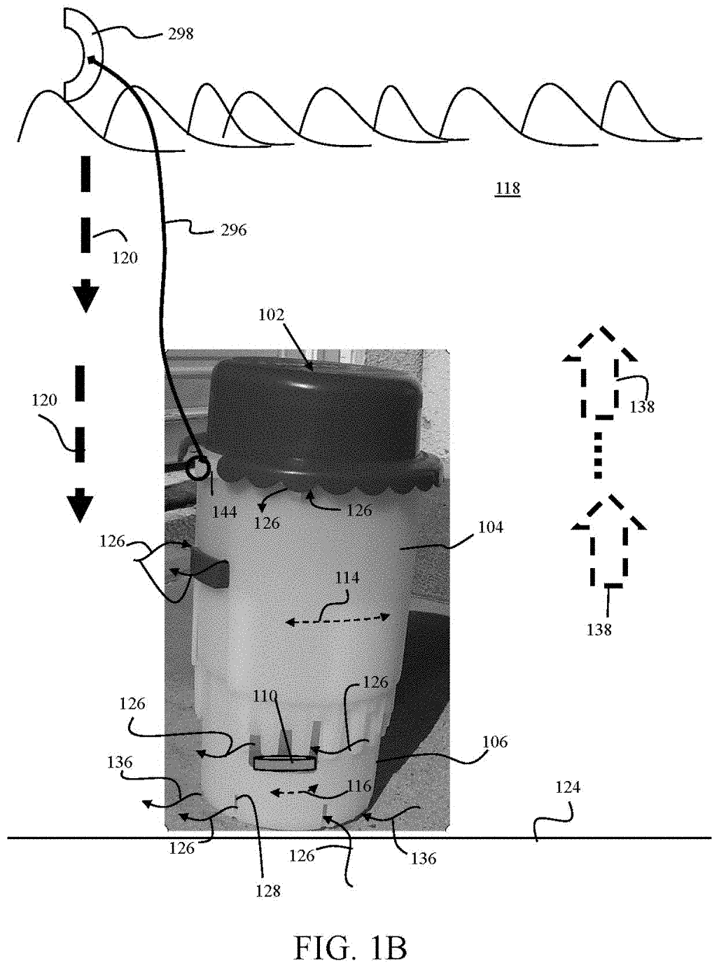

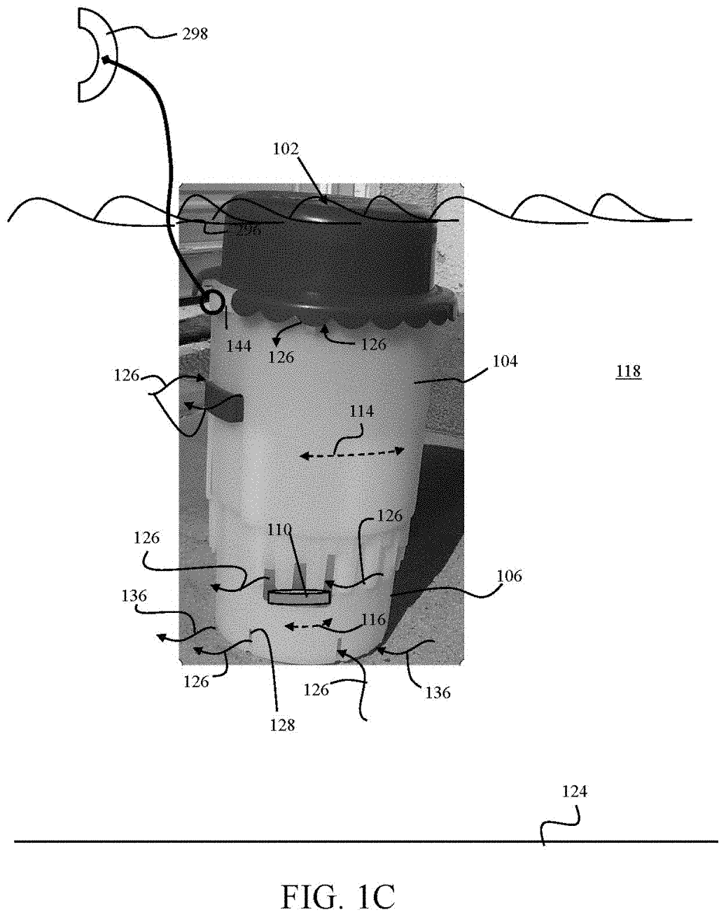

FIGS. 1A to 1C are non-limiting, exemplary illustrations of a compound dispenser device in accordance with one or more embodiments of the present invention. FIG. 1A is a non-limiting, exemplary illustration of the compound dispenser device being side-loaded with compounds in accordance with one or more embodiments of the present invention. FIG. 1B is a non-limiting, exemplary illustration of a not-to-scale, and much enlarged view of the compound dispenser device shown in FIG. 1A used in sink mode, shown at the bottom of an enclosed body of water in accordance with one or more embodiments of the present invention. FIG. 1C is a non-limiting, exemplary illustration of a not-to-scale, and much enlarged view of the compound dispenser device shown in FIG. 1A used in float-mode floating at a surface of an enclosed body of water in accordance with one or more embodiments of the present invention.

As illustrated in FIGS. 1A to 1C and further detailed below, compound dispenser device (herein after referred to as simply “device”) 100 is comprised of a cap 102, a first member 104, with cap 102 detachably associated with first member 104, and a second member 106 wherein first and second members 104 and 106 are moveably associated with one another (further detailed below).

As shown, first and second members 104 and 106 define a side opening 108 of device 100 that varies in size (detailed below), as first and second members 104 and 106 move in relation to one another where a compound (e.g., chlorine tablets 110) may be side loaded as shown by arrow 112 into device 100 through side opening 108 without removing cap 102. Of course, if a larger number of compounds 110 is to be added where already side loaded compounds 110 may block insertion of more, then cap 102 may be removed and more compound 110 added from the top of device 100.

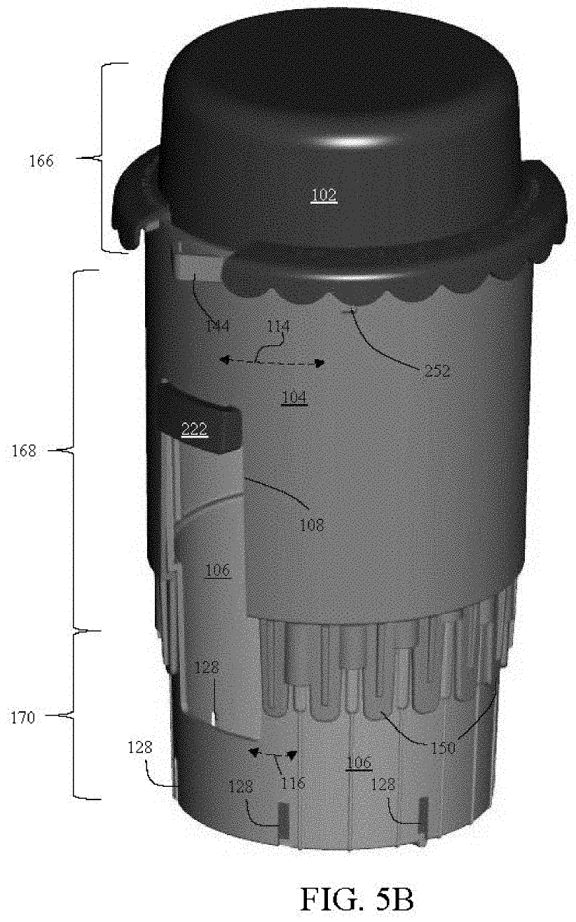

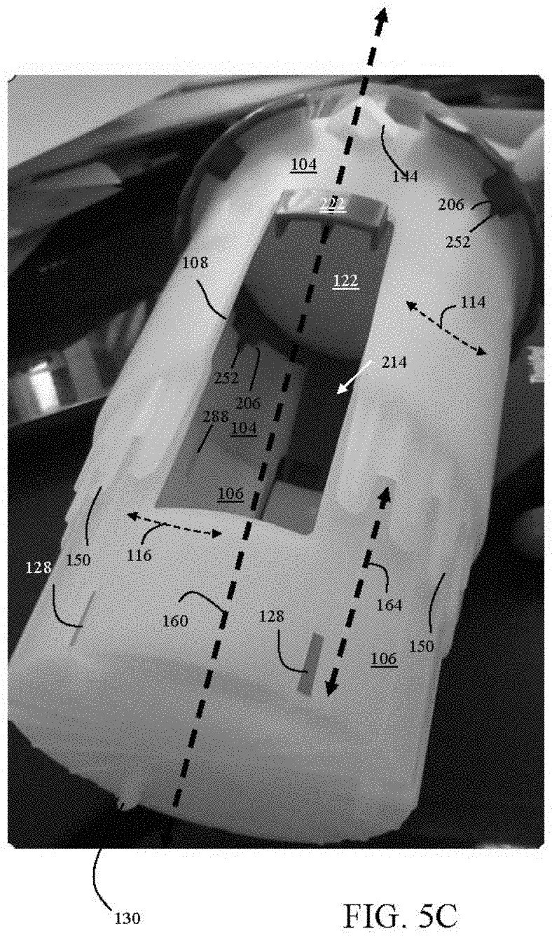

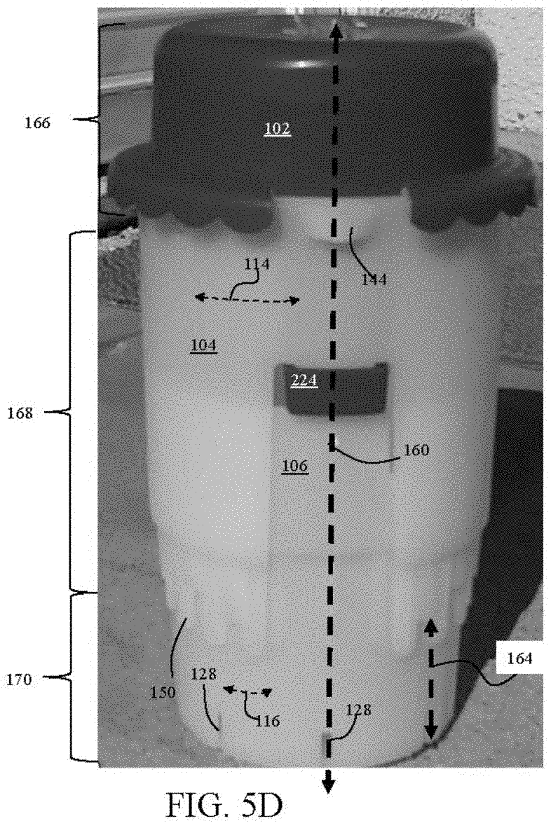

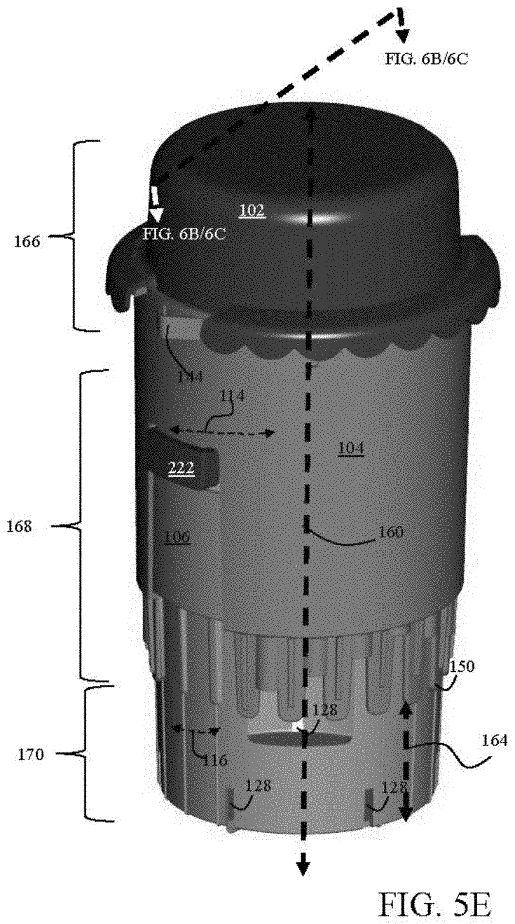

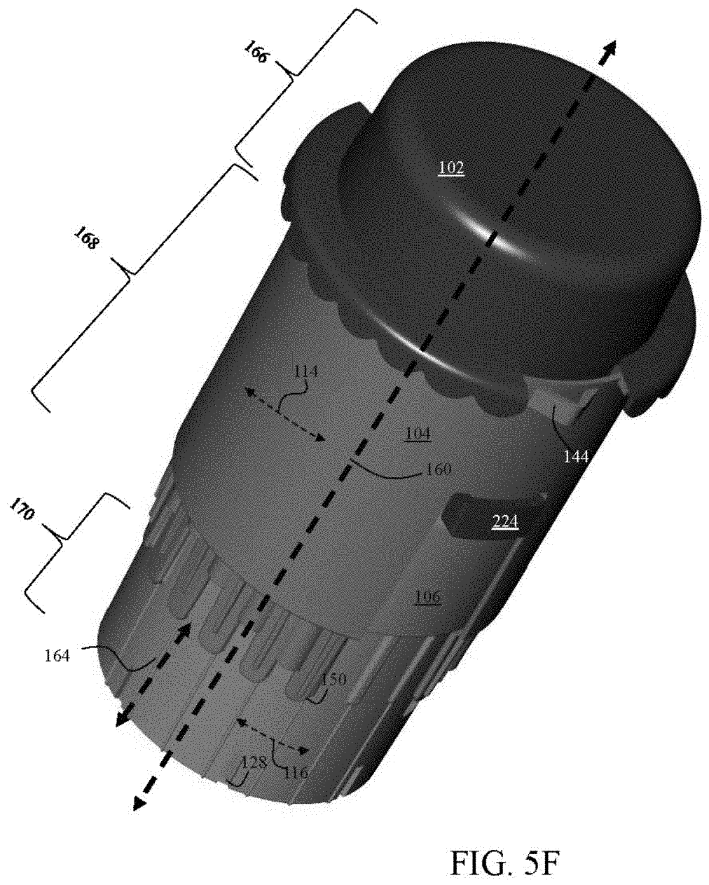

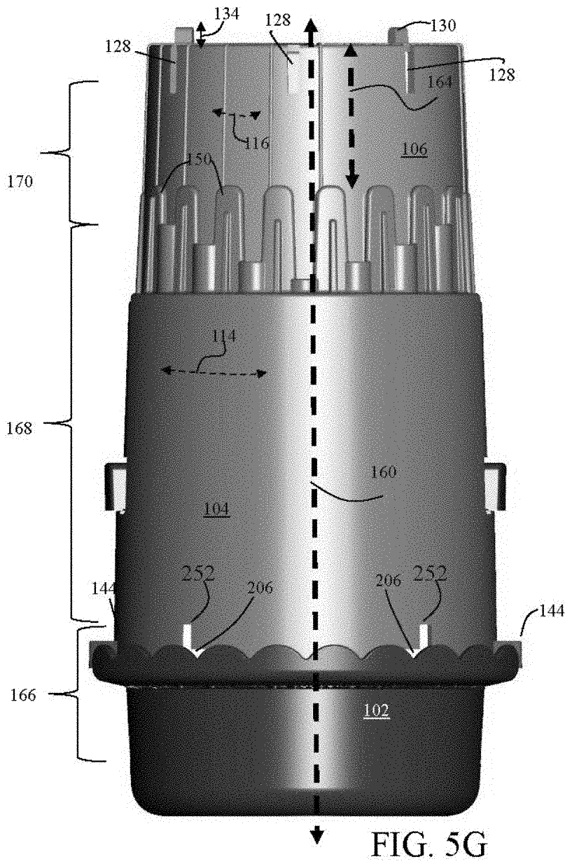

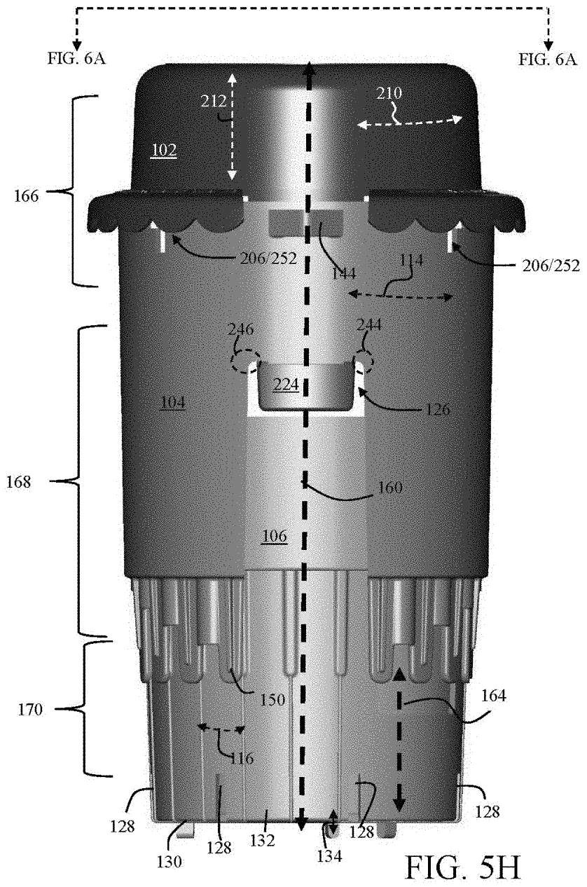

As best shown in FIG. 1B (sink-mode use), once loaded with compound 110, first and second members 104 and 106 may be moved in relation to one another, as shown by respective arrows 114 and 116 to close side opening 108. Once side opening 108 is closed, device 100 may be released into a closed body of water (e.g., a swimming pool) 118, where it would simply sink (as shown by arrows 120) to bottom 124 of pool 118. The weight of compound 110 inside device 100 overcomes the buoyancy force of a floatation element 122 (detailed below and shown in FIG. 5C) associated with cap 102, sinking the entire device 100.

Optionally, device 100 may be connected (using its integral tie-down 144) by a cord or other means 296 onto a fixed structure 298 to restrict its movement within a certain area of pool 118, keeping device 100 away from the pool pump.

Device 100 would remain at or near bottom 124 of pool 118 until compound 110 begins to gradually dissolve. As compound 110 gradually dissolves, the buoyancy force of floatation element 122 overcomes the weight of the now much lighter, dissolved compound 110, gradually pulling device 100 towards the water surface (as shown by arrows 138). In other words, compound 110 functions as a counter-weight to the buoyancy force of floatation element 122.

Device 100 may sink to bottom 124 of most average size pools with average depths of about 6 to 10 feet when fully loaded with compound 110. Device 100 may remain there at or near bottom 124 for two, three, or more days until compound 110 is continuously and gradually dissolved. Gradual dissolving of compound 110 enables commensurately gradual resurfacing of device 100 due to the buoyancy force of floatation element 122.

Given that device 100 remains under water as compound 110 is gradually dissolved, no part of device 100 floats above water to be affected by intense sunlight and reflections thereof from water. Accordingly, the impingement of the rays of the sunlight and its reflections will not have effect on device 100 to generate heat in the interior of device 100 and therefore, would not cause compound 110 therein to deplete quicker. Therefore, device 100 makes very efficient use of compound 110.

As importantly, since device 100 sinks to the bottom 124 of pool, any amount of compound 110 dissolved is released within deep water also. Therefore, any released compound 110 (such as chlorine) is better protected from heat and ultraviolet rays from the sun, which may potentially neutralize compound 110.

As compound 110 continues to dissolve, device 100 continues to gradually float upward 138 to higher and higher elevations of water depth while continuously releasing or dispersing dissolved compound 110 at different elevations of water depth. In addition, and as further detailed below, device 100 includes a plurality of openings through which water may flow in and out of device 100 at different levels of device 100 as shown by arrows 126. Accordingly, one or more embodiments of the present invention provide a device 100 that efficiently disperses the compound from multiple levels of device 100 and at different elevations of water, providing proper flow of water through dispenser at different levels and elevations.

Since device 100 floats to the surface of water once compound 110 is substantially dissolved to a point where buoyancy of the floatation element 122 overcomes the weight of any remaining compound 110, device 100 provides a clear indication to replenish the substantially depleted compound as its cap 102 fully floats above water surface. Accordingly, resurfacing of cap 102 of device 100 fully above water is a very clear indication to users that compound 110 should be replenished.

It should be noted that any remaining or residual compound 110 within device 100 would continue to dissolve and be dispersed at different levels of device 100 even when device 100 resurfaces.

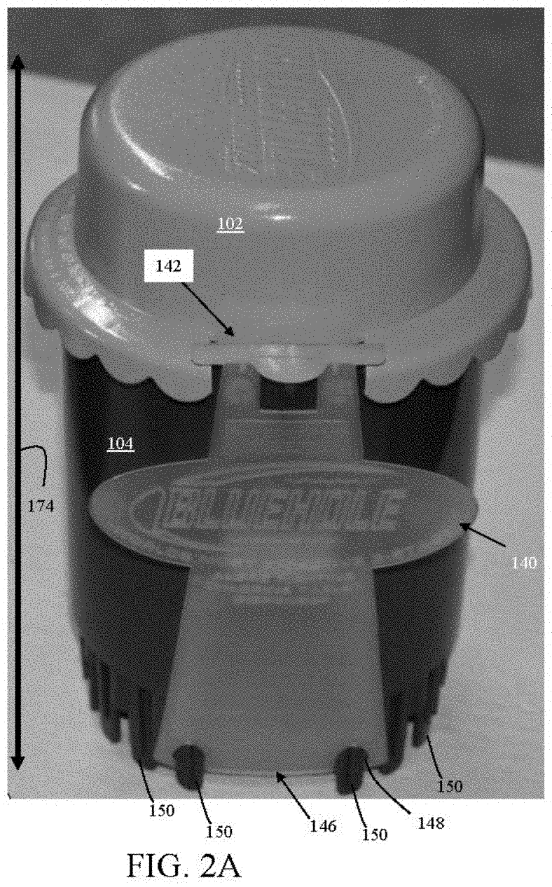

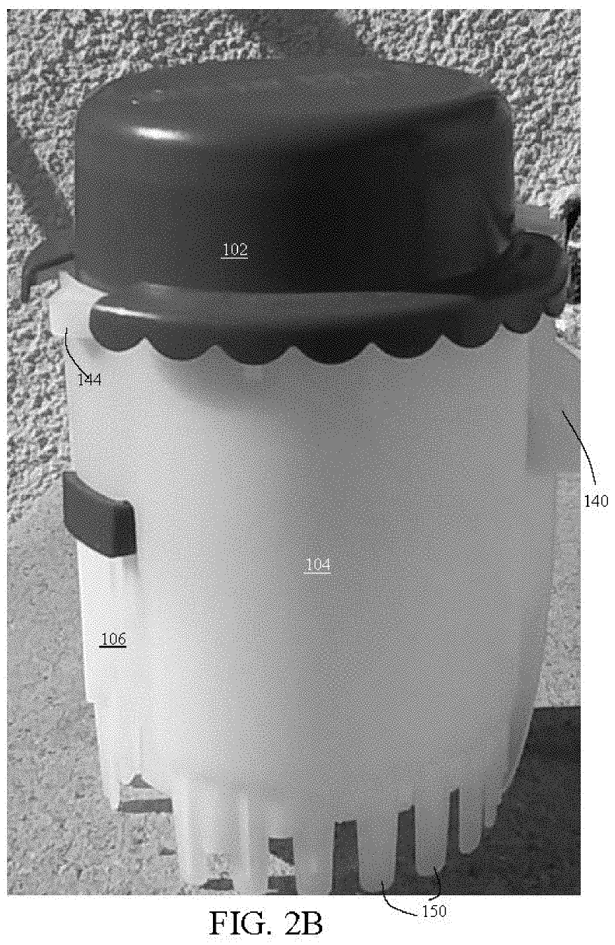

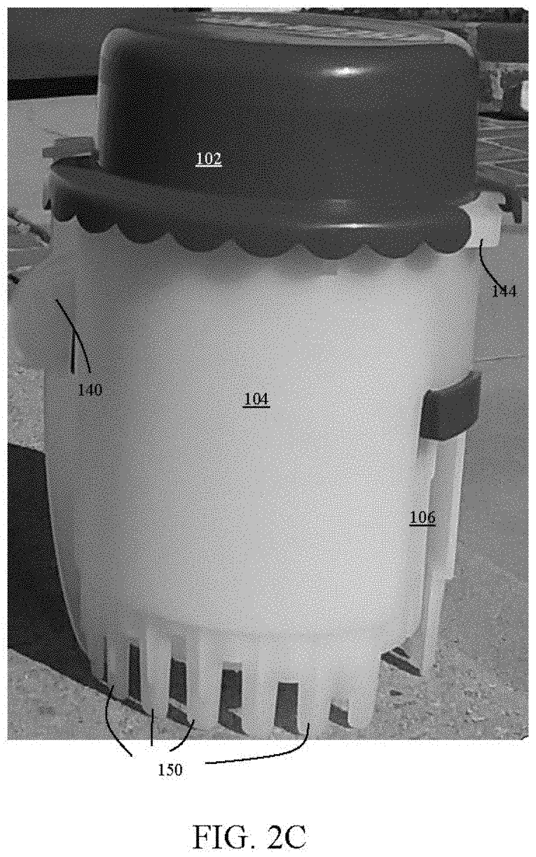

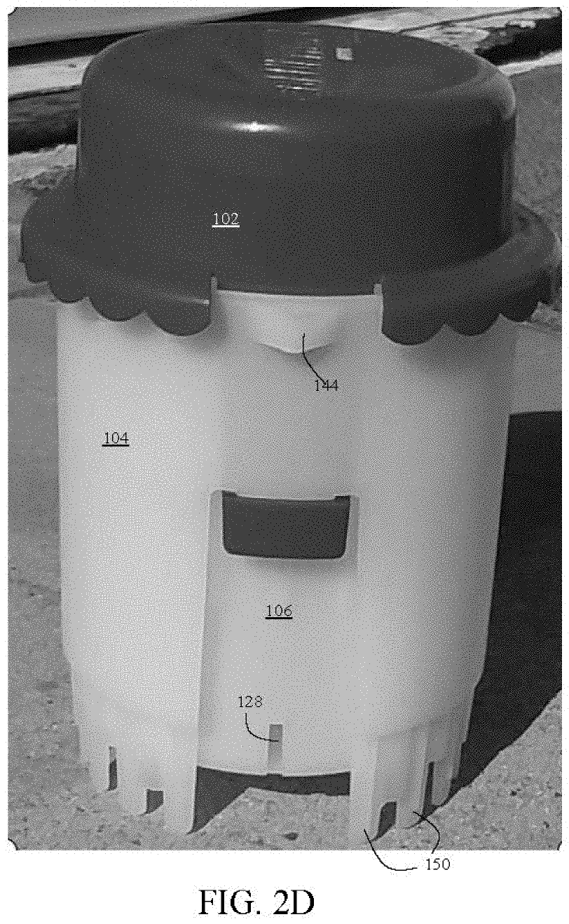

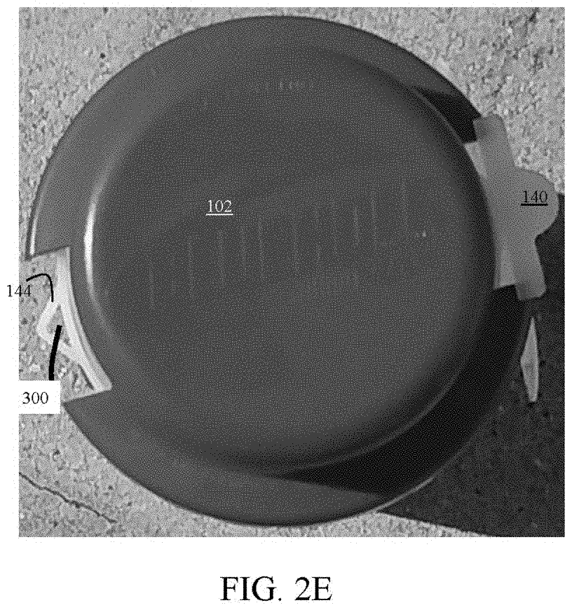

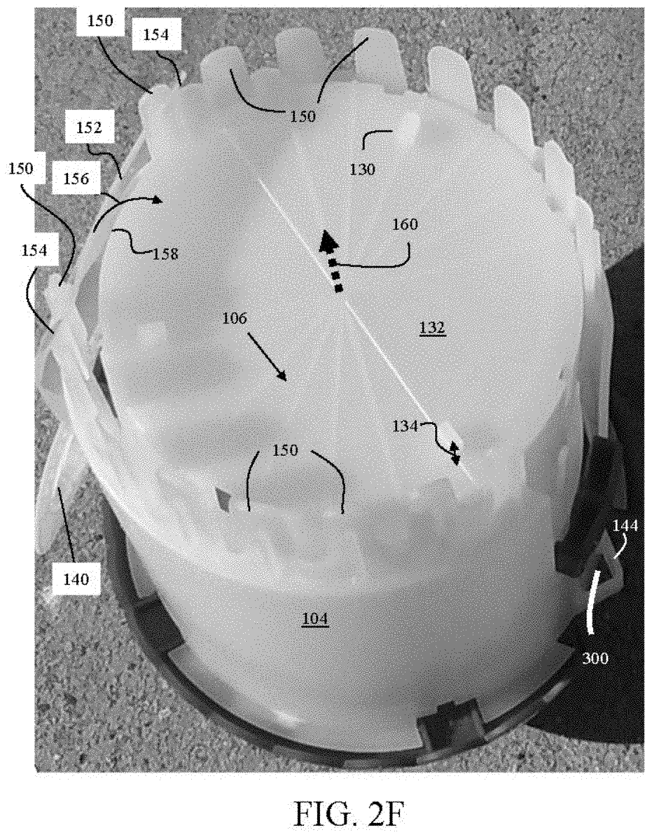

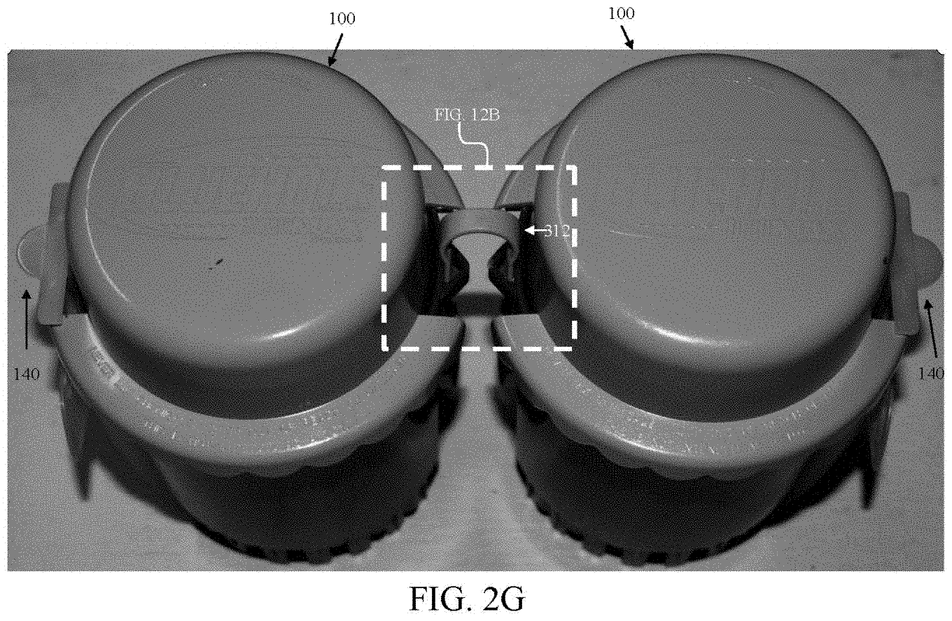

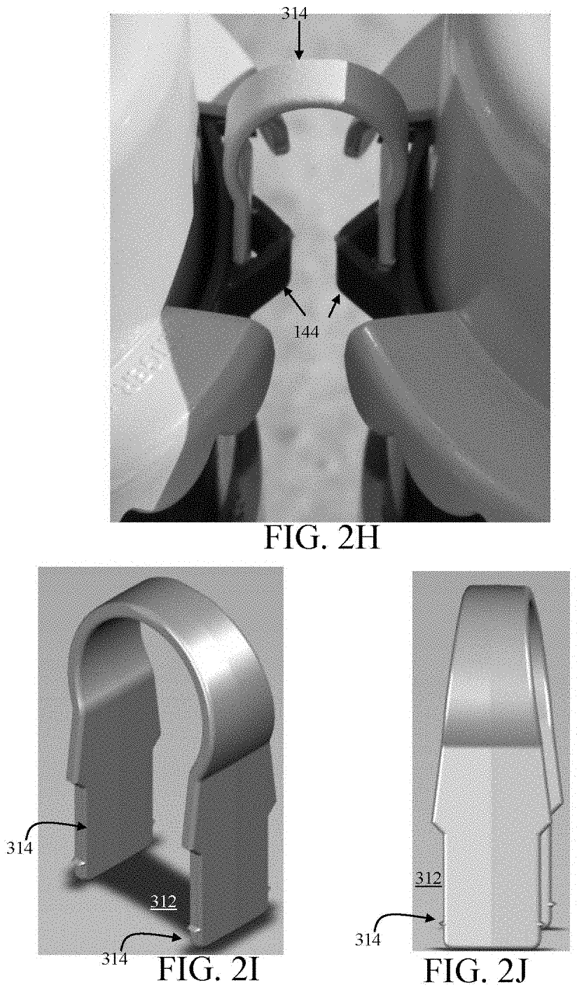

As further detailed below, the entire device 100 (and in particular, second member 106) is supported by a set of stands (or legs) 130 (shown in FIG. 2F) that raise bottom openings 128 from bottom floor 124 of pool 118 at a height 134 of stands 130. This raised elevation of bottom exterior surface 132 of second member 106 allows for undercurrent water flows (shown by arrows 136) to move underneath bottom exterior surface 132. Accordingly, as device 100 potentially may linger on floor 124 of pool 118, the high concentrations of dissolved compound 110 at the lingering location would quickly be dispersed via undercurrents 136, preventing damage to paint or other materials of floor 124.

As indicated above, FIG. 1C is a non-limiting, exemplary illustration of device 100 used in float-mode. Once loaded with compound 110 as shown in FIG. 1A, first and second members 104 and 106 may be moved in relation to one another, as shown by respective arrows 114 and 116 to close side opening 108. Once side opening 108 is closed, device 100 may be released into a closed body of water (e.g., a swimming pool) 118, where it would simply float on the surface of the water as shown. In this non-limiting, exemplary instance where device 100 is used in float-mode, the adjusted weight of compound 110 inside device 100 would not completely overcomes the adjustable buoyancy force of the adjustable floatation element 122, enabling the entire device 100 to float in water as shown. As detailed below, buoyancy of device 100 may be adjusted depending on adjustments related to floatation element 122 and also, amount of compound 110 used. Accordingly, cap 102 may easily float above water even if newly loaded with compound 110.

As further illustrated, when used in float mode, body of device 100 sits deep in water while floating near top surface of the water and further, may float and travel through a greater area of the body of water due to its generally lighter weight and a more compact form-factor. As with sink-mode shown in FIG. 1B, in float-mode use shown in FIG. 1C, device 100 provide the benefits of efficiently dispersing compound 110 from multiple levels of device 100 and at different elevations of water (near water surface), providing proper flow of water through device 100 at different levels and elevations.

FIGS. 2A to 2J are non-limiting, exemplary illustrations of the various views of the compound dispenser device shown in FIGS. 1A to 1C, but in a fully retracted, stored state in accordance with one or more embodiments of the present invention. As illustrated, device 100 is only about 7 inches in length 174 in a retracted, stored state, having a very compact form-factor. Further, device 100 is about 12 inches in length 176 (FIG. 5A) in an extended or protracted position. Overall width 178 (FIG. 5A) of device 100 is about 3 to 4 inches.

In the retracted (or telescopically collapsed), stored state, device 100 may include a flexible retainer band 140 that holds together first and second member 104 and 106 so that they do not expand (or protract) telescopically. In the stored position, device 100 may include one or more compound 110 already stored within and positioned in a shelf for sales.

FIGS. 2G to 2J are non-limiting, exemplary views of two compound dispenser device shown in FIGS. 1A to 2F in a fully retracted, stored state connected together with a flexible connector strap in accordance with one or more embodiments of the present invention. As illustrated, two devices 100 may be detachably connected together by a detachable flexible connector strap 312. Detachable flexible connector strap 312 has a generally U-shaped configuration with free ends 314 that are inserted into openings 300 of tie-down 144 of device 100.

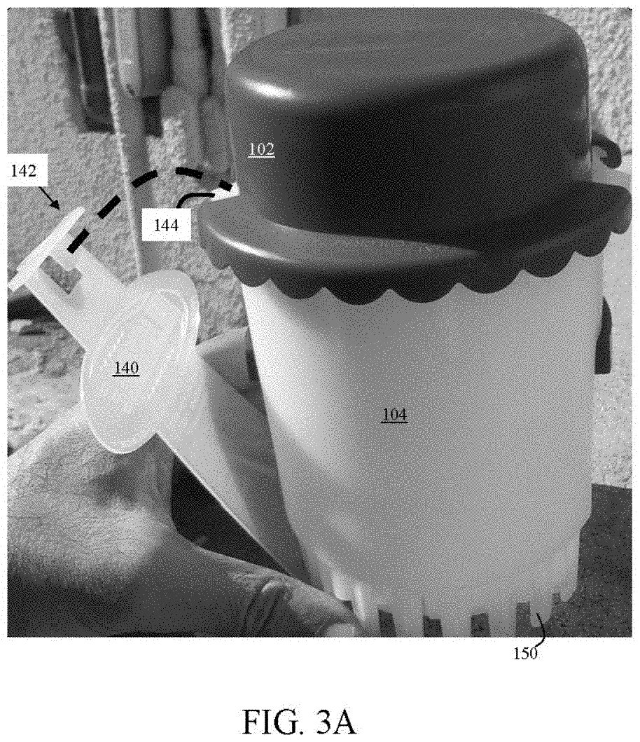

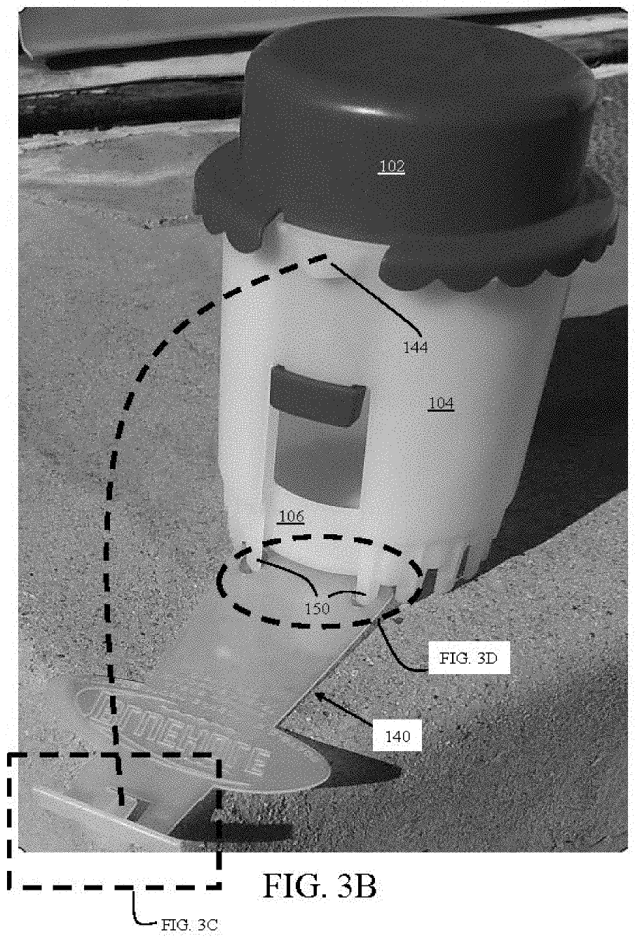

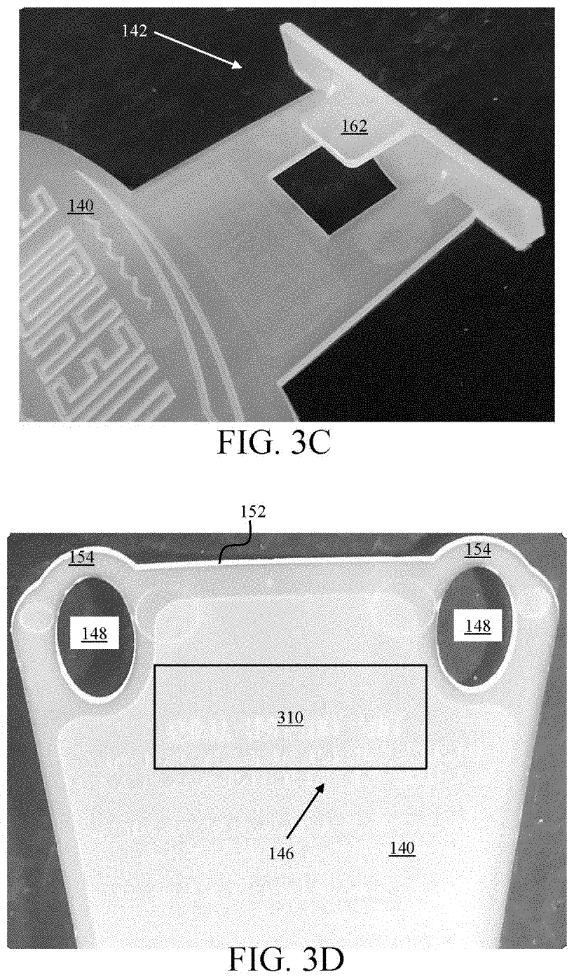

FIGS. 3A and 3B are non-limiting, exemplary illustrations of the various views of a single compound dispenser device shown in FIGS. 1A to 2J, progressively illustrating a removal of the retainer band in accordance with one or more embodiments of the invention. FIGS. 3C and 3D illustrate details of the connecting structure of the retainer band in accordance with one or more embodiments of the present invention.

As illustrated in FIGS. 2A to 3D, retainer band 140 includes a first end 142 that connects with tie-down 144 (detailed below) of first member 104, and a second end 146 comprised of openings 148 through which free ends of damper supports 150 of first member 104 extend.

First end 142 of retainer band 140 includes a flange or a hook 162 that engages (is inserted into) opening 300 (FIG. 2E) of tie-down 144. Second end 146 of retainer band 140 includes a recess bottom edge portion 152 and extended bottom edge portions 154 (adjacent openings 148) that frictionally obstruct and block bottom exterior edge 158 of exterior bottom side 132 of second member 106, which prevents second member 106 from telescopically expanding to protracted or fully extended position. That is, when retainer band 140 is fully attached, bottom edge portions 152 and 154 bend inward (shown as arrow 156 in FIG. 2F) towards central longitudinal axis 160 of device 100, preventing second member 106 from telescopically moving out of first member 104. It should be noted that second end 146 of retainer band 140 has sufficient space for positioning a Universal Product Code (UPC), Quick Response Code (QR), or other codes 310 thereon.

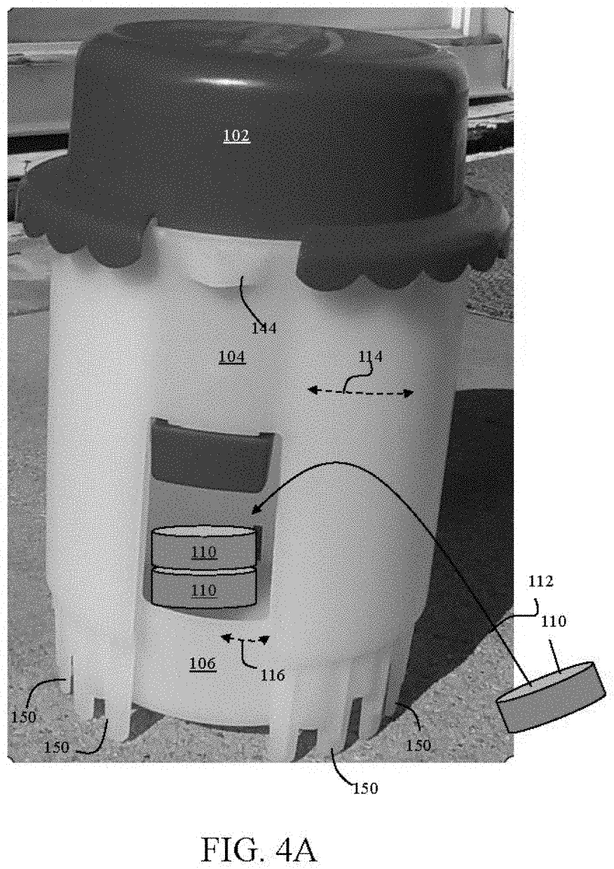

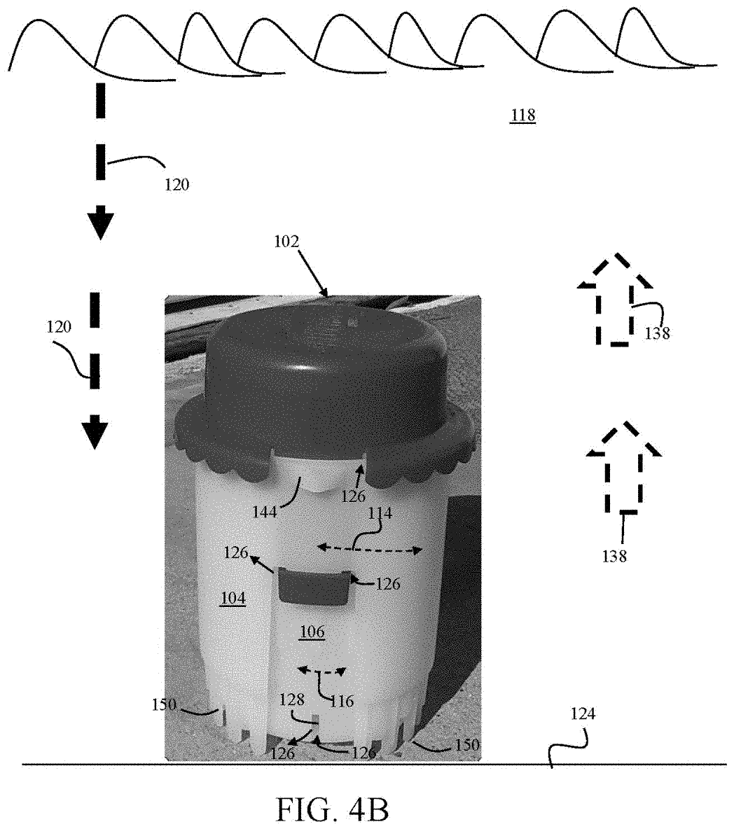

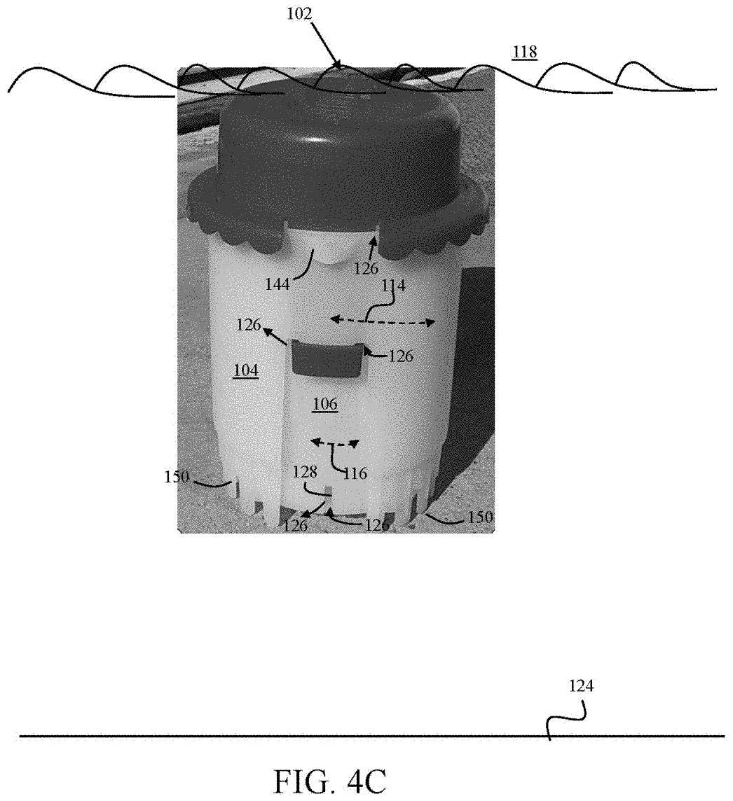

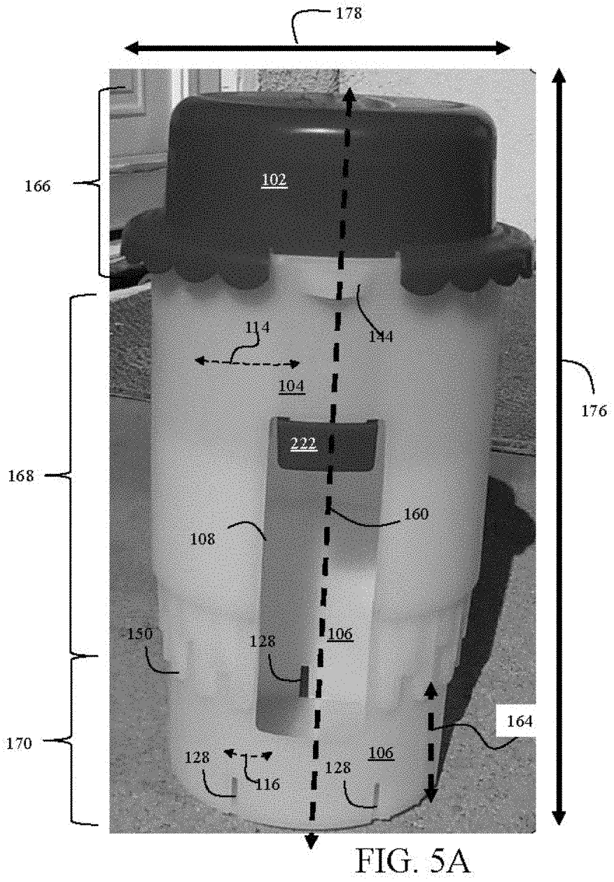

FIGS. 4A to 4C are non-limiting, exemplary illustrations of the lateral views of the compound dispenser device shown in FIGS. 1A to 3D, in a fully retracted, collapsed position with retainer band removed in accordance with one or more embodiments of the present invention. FIG. 4B is a non-limiting, exemplary illustration of a not-to-scale, and very enlarged view of the compound dispenser device in a collapsed position used in sink mode, shown at a bottom of an enclosed small body of water such as a fountain in accordance with one or more embodiments of the present invention. FIG. 4C is a non-limiting, exemplary illustration of a not-to-scale, and very enlarged view of the compound dispenser device in a collapsed position used in float mode in accordance with one or more embodiments of the present invention.

Device 100 may be used in a fully retracted, collapsed position in the same manner as shown and described in relation to FIGS. 1A to 1C (in sink or float modes). As shown in FIG. 4A, device 100 may be side-loaded with an appropriate amount of compound 110 as shown by arrow 112 in FIG. 4A. Once loaded with compounds, first and second members 104 and 106 may be rotated (as shown by arrows 116 and 114) to further enclose side opening 108 to a selected size, further restricting water flow. Thereafter, as shown in FIG. 4B (in sink mode), compound loaded device 100 may be released or placed in the body of water 118, sinking to the bottom 124, with water flows 126 at different heights of device 100 releasing dissolved compound into water. However, as shown in FIG. 4C (in float mode), compound loaded device 100 may be released or placed in the body of water 118, floating on top surface as shown, with water flows 126 at different heights of device 100 releasing dissolved compound into water.

The amount of compound 110 loaded into device 100 when in retracted position would be less as the interior chamber defined by first and second members 104 and 106 therein has less space since device 100 is in the collapsed position. Accordingly, in retracted, collapsed position, device 100 may be used in smaller enclosed body of water (e.g., a fountain) rather than a large swimming pool.

A critical and advantageous reason for enabling varying the size of device 100 is that the size variation allows the same device 100 to be used in both larger sized body of water (e.g., a pool) when fully protracted (or expanded) and allows the same device 100 to be used in a smaller sized body of water (e.g., a fountains or spa) when used in retracted, collapsed position.

FIGS. 5A to 5I are non-limiting, exemplary illustrations of compound dispenser device shown in FIGS. 1A to 4C in a fully extended (or protracted) position in accordance with one or more embodiments of the present invention. As illustrated, device 100 includes cap 102 detachably associated with first member 104.

Second member 106 is moveably associated with first member 104, with first and second members 104 and 106 defining side opening 108 of device 100 that varies in size as first and second members 104 and 106 move.

First member 104 and second member 106 are axially and rotatably associated with one another. That is, first and second members 104 and 106 move axially 164 along central longitudinal axis 160 of device 100, to telescopically move to one of a retracted (or collapsed) position (FIGS. 2A to 4C) and a protracted (or extended) position (FIGS. 5A to 5I) of device 100. Further, first and the second members 104 and 106 rotate (shown by arrows 114 and 116) about central longitudinal axis 160 of device 100.

As further detailed below, first and second members 104 and 106 define various openings of device 100 along an upper section 166, a general middle section 168, and a lower section 170 of device 100 for flow of water through device 100 at different levels of water depth even if device 100 is stationary within water. As further detailed below, openings at the general middle section 168 of device 100 vary in size.

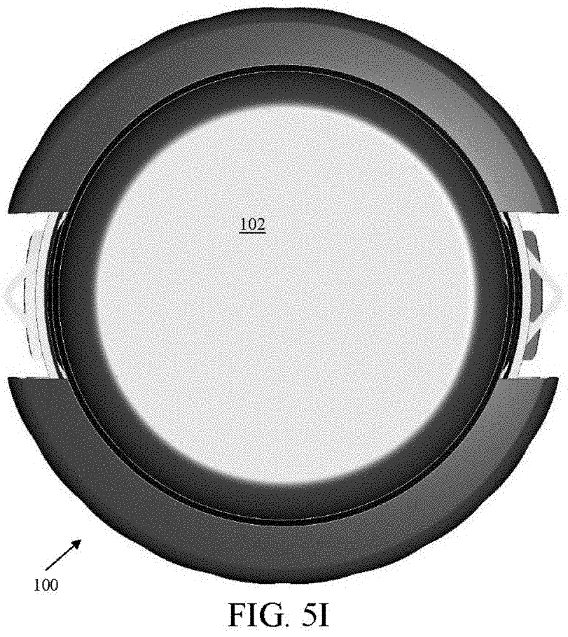

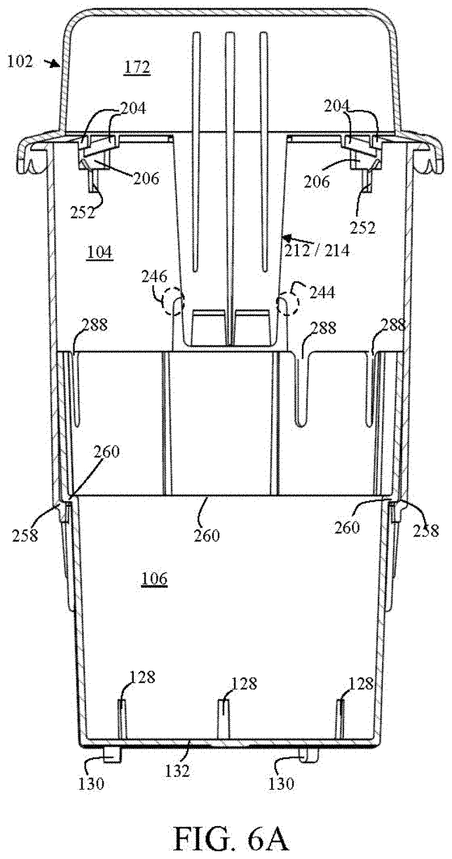

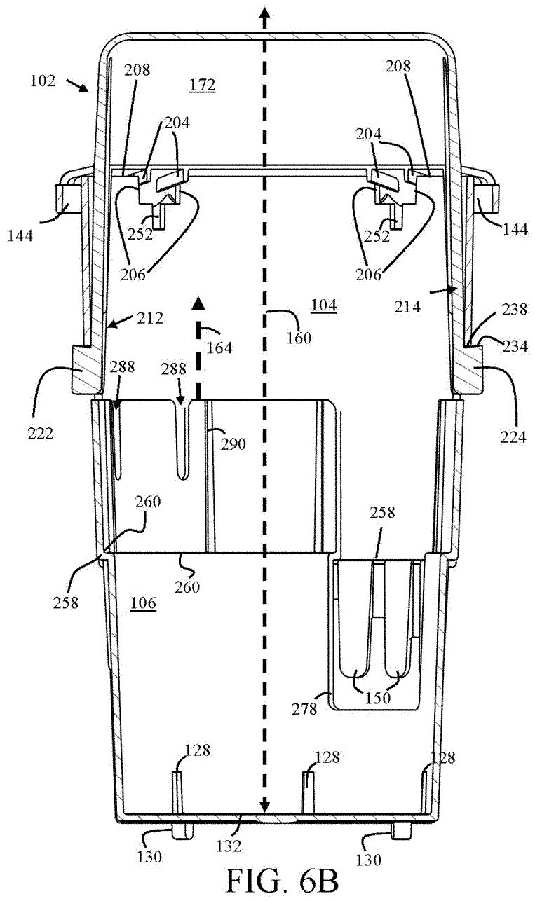

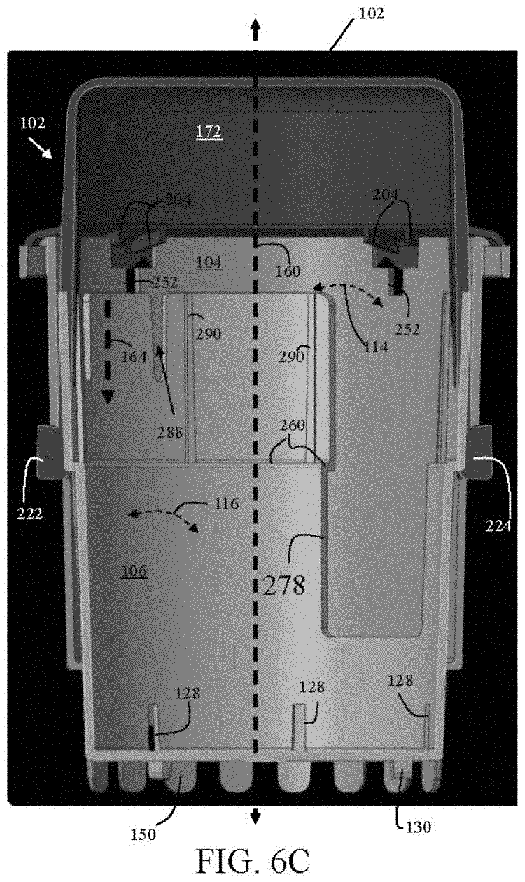

FIGS. 6A to 6C are non-limiting, exemplary illustrations of various sectional views of the compound dispenser device shown in FIGS. 1A to 5I in accordance with one or more embodiments of the present invention. As illustrated, second member 106 is telescopically moved within first member 104 axially 164 along central longitudinal axis 160 from an extended (or protracted) position (FIGS. 6A and 6B) to a retracted or collapsed position (FIG. 6C). While in the retracted position as shown in FIG. 6C, first and second members 104 and 106 may also easily rotate in relation to one another as shown by arrows 114 and 116.

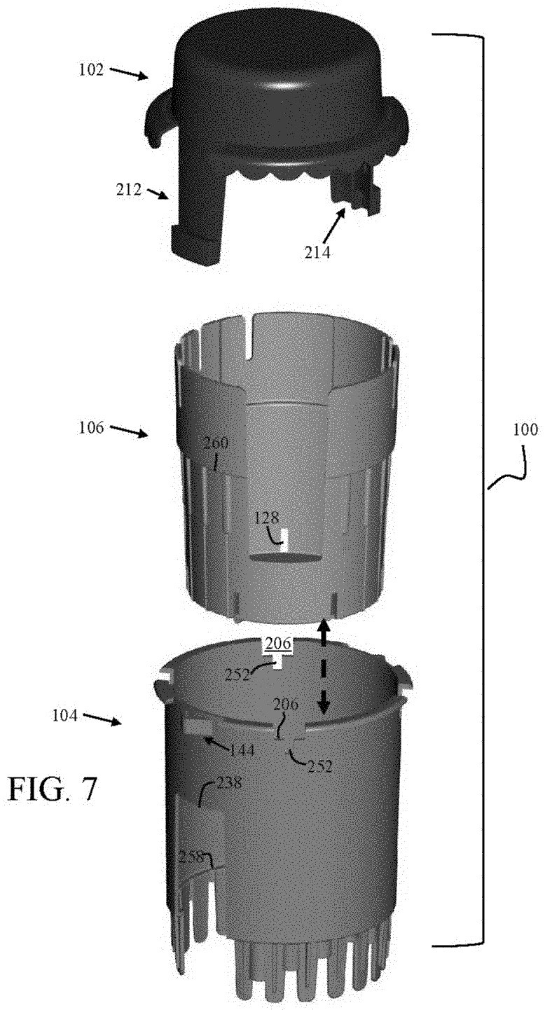

FIG. 7 is a non-limiting exemplary exploded view illustration of the various components of the compound dispenser device shown in FIGS. 1A to 6C in accordance with one or more embodiments of the present invention. The exploded view shown in FIG. 7 illustrates disassembled, separated components that show the cooperative working relationship, orientation, positioning, and exemplary manner of assembly of the various components of device 100 in accordance with one or more embodiments of the present invention, with each component detailed below.

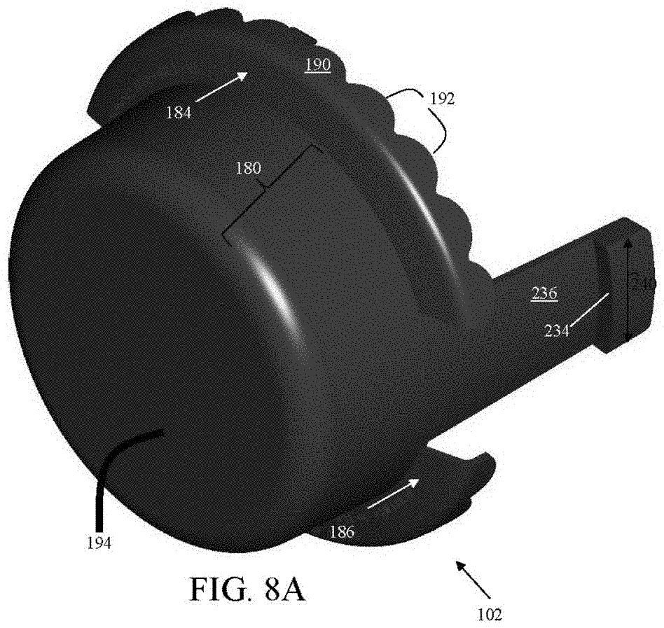

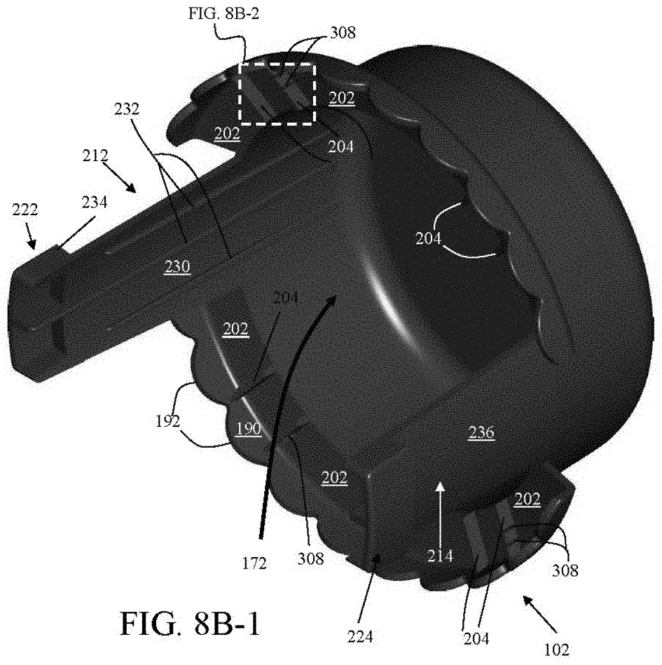

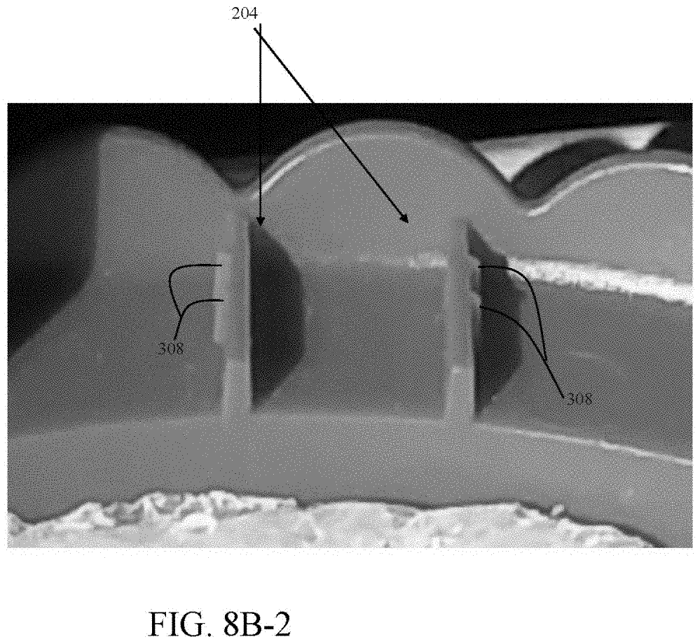

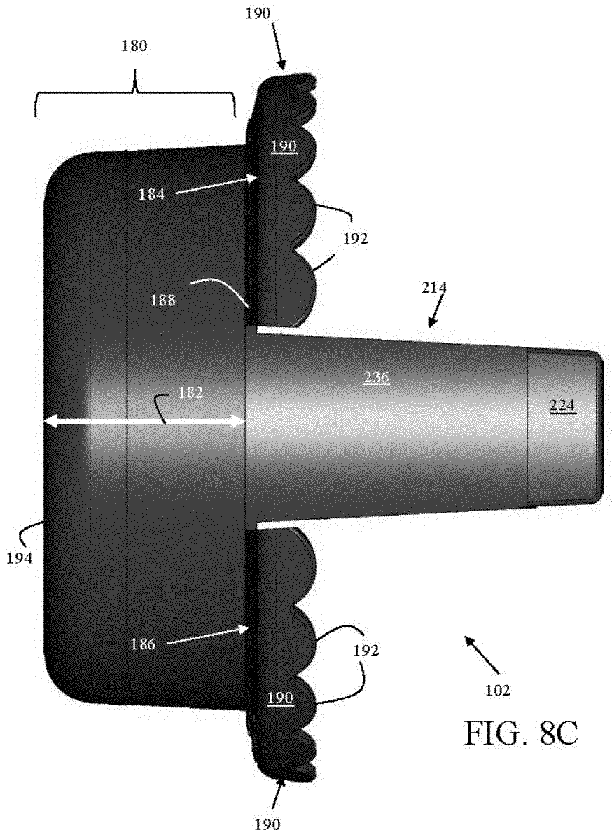

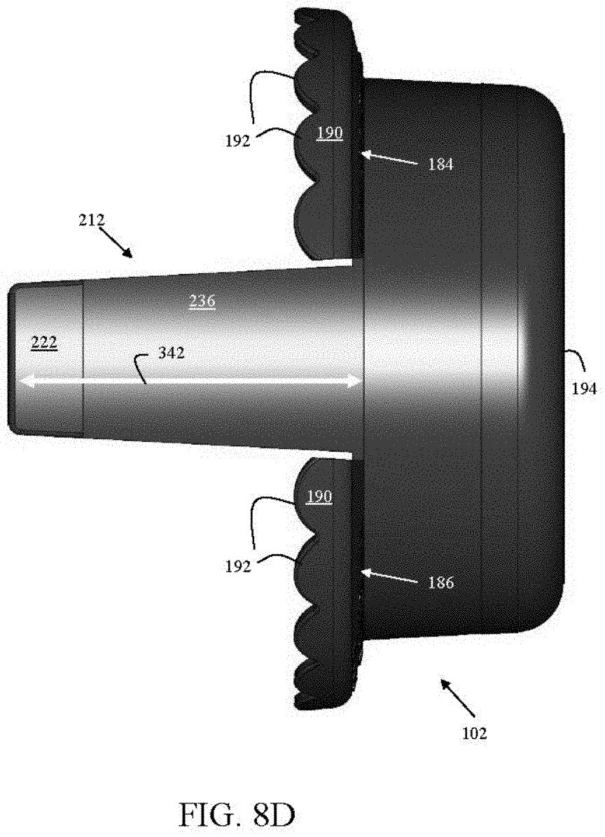

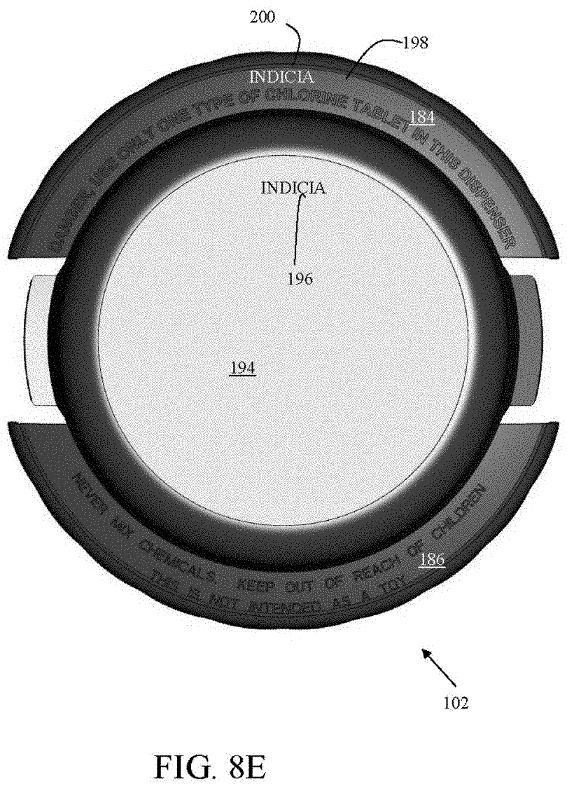

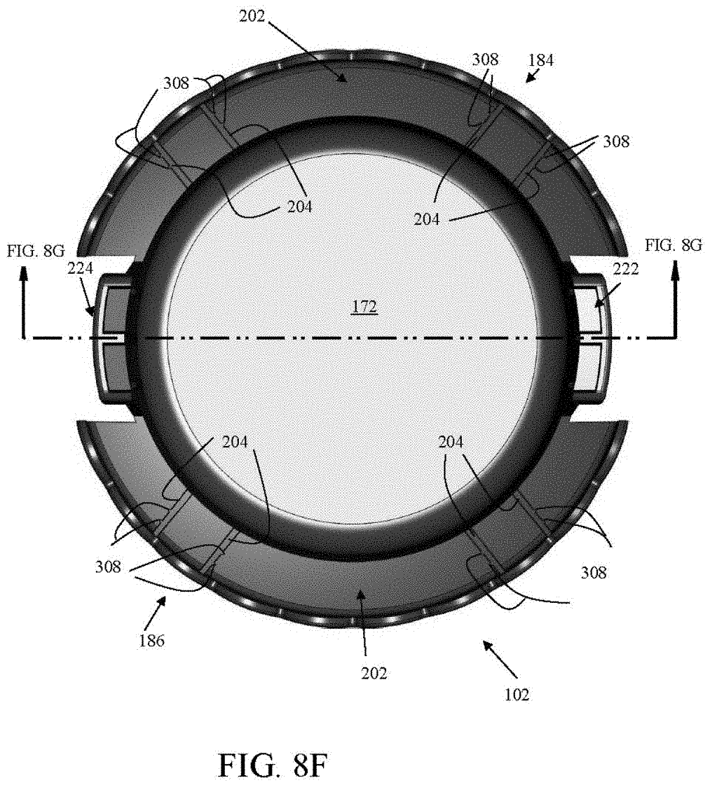

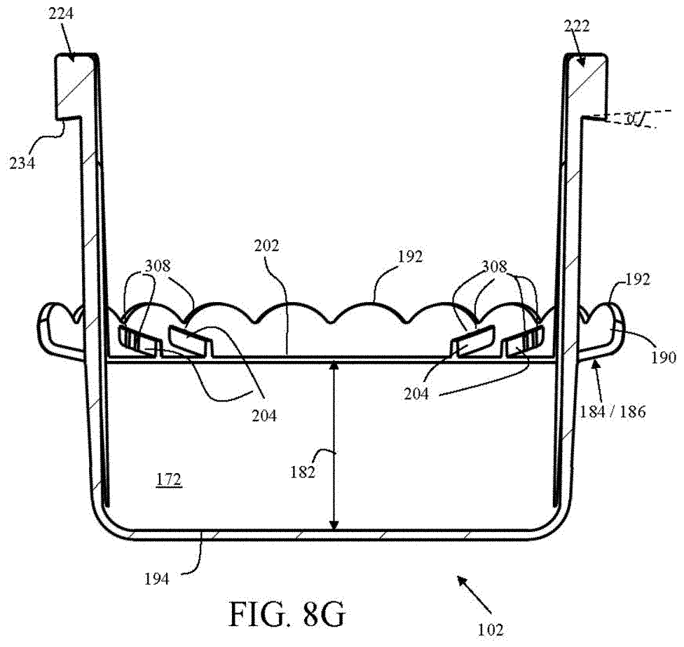

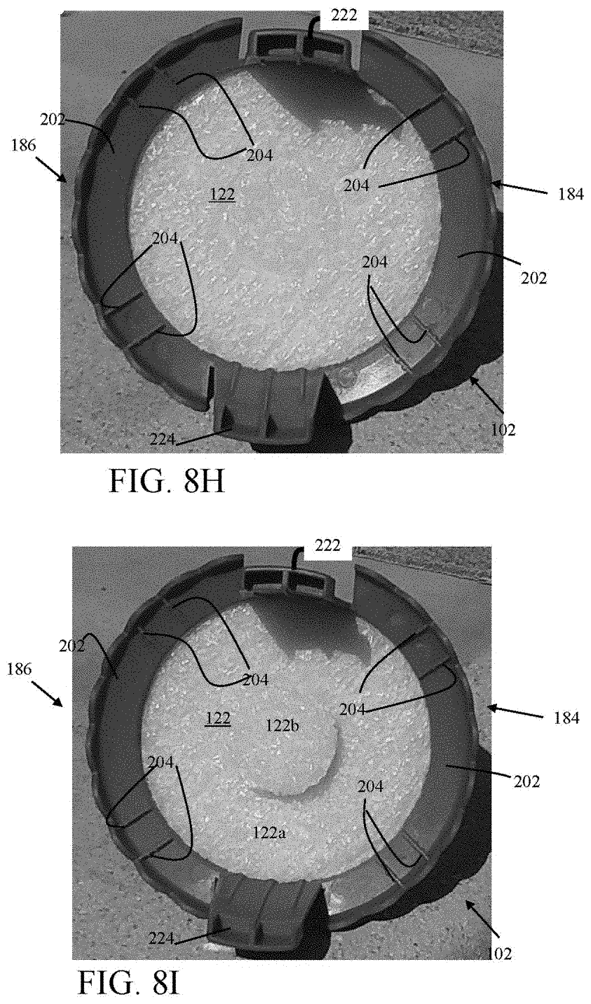

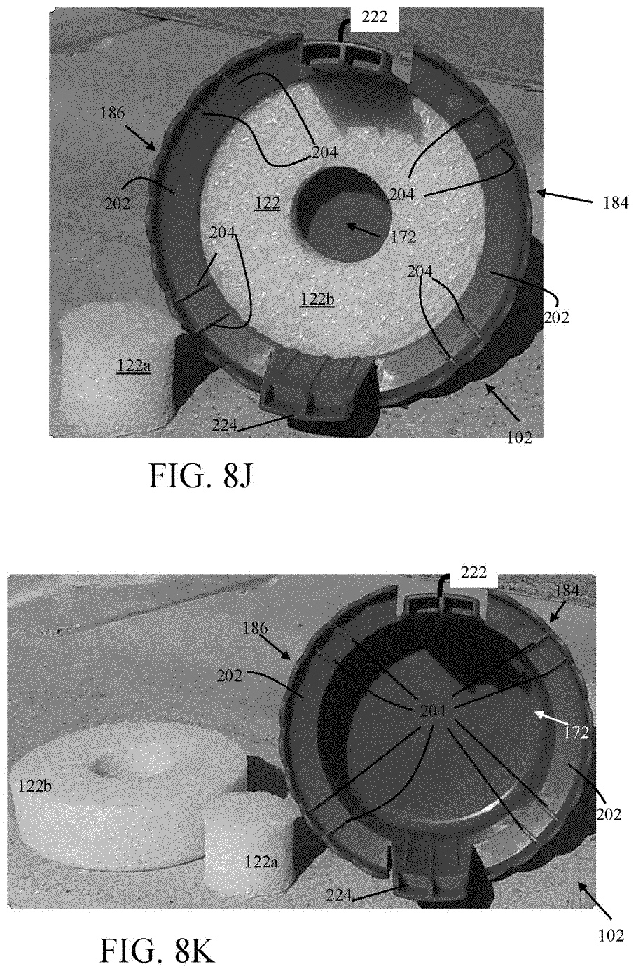

FIGS. 8A to 8K are non-limiting, exemplary illustrations of the various views of a cap of the compound dispenser device shown in FIGS. 1A to 7, including one or more floatation elements in accordance with one or more embodiments of the present invention. As illustrated, cap 102 of device 100 is comprised of an interior cavity 172 within which floatation element 122 is friction-fit secured. It should be noted that more floatation elements 122 may be stacked on top of one another, friction-fit secured in between Inner side surfaces 230 along heights 342 of snap joints 212 and 214.

Cap 102 has cap body 180 configured as a cylindrical disk with a height 182, and semi-circumferentially projecting rims 184 and 186 at a bottom 188 of cap body 180, which in this non-limiting, exemplary embodiment may be identical. Cap body 180 enables users to grip cap 102 (including undulation 192) to hold device 100, functioning as “handle” to lift device 100 from or release it into 100 in water.

Semi-circumferentially projecting rims 184 and 186 define downward pointing flanges 190 with undulation design 192 that are esthetically pleasing, similar to a shroud covering.

A top surface 194 of cap body 180 has an indicia (e.g., a printed marker) 196 that, when at water surface, indicates that compound 110 within device 100 is full. Atop surface 198 of projecting rims 184 and 186 have an indicia (e.g., a printed marking) 200 that when above the water surface and visible, indicate that compound 110 within device 100 is depleted. In other words, height 182 of cap body 180 below water indicates that compound 110 within the device is full. However, height 182 of cap body 180 above water indicates that compound 110 within device 100 is depleted.

It should be noted that cap body 180 floating above or below water surface depends on many factors (including buoyancy force) and not just depletion of compound 110. For example (and as detailed below), the buoyancy of device 100 may be adjusted depending on adjustments related to floatation element 122. Accordingly, cap 102 may easily float above water even if newly loaded with compound 110.

A bottom surface 202 of projecting rims 184 and 186 is comprised of interlocking stiffener projections 204 that when aligned with corresponding interlocking notches 206 on a support flange 208 of first member 104 prevent cap 102 from rotating when cap 102 is in a fully closed position in relation to first member 104. This provides for a tighter, cleaner fit with minimal play (if any).

In this non-limiting, exemplary instance, bottom surface 202 of projecting rims 184 and 186 includes four sets of interlocking stiffener projections 204, and support flange 208 of first member 104 includes four interlocking notches 206.

Interlocking stiffener projections 204 and the corresponding interlocking notches 206 prevent in-plane rotational movement 210 of cap 102 while snap joints 212 and 214 (detailed below), prevent axial movement 216 of cap 102 along longitudinal axis 160 of device 100. The remaining bottom surface 202 of projecting rims 184 and 186 rests on top 220 of or is supported by support flange 208 of first member 104. Accordingly, cap 102 may be removed easily by a user, but remains secure in relation to first member 104 once mounted.

As best illustrated in FIGS. 8B-1, 8B-2, 8F, and 8G, every single interlocking stiffener projection 204 includes lateral protrusions 308. Accordingly, each pair of interlocking stiffener projection 204 includes four lateral protrusions 308 (or each interlocking stiffener projection 204 has two lateral protrusions 308, best shown in FIG. 8B-2). Lateral protrusions 308 function as “crush ribs” to generate a tighter (or interference) fit (including alignment) with interlocking notches 206 for a tighter fit of cap 102 onto first member 104.

As illustrated, cap 102 further includes snap joints 212 and 214 (generally known as cantilever snap joints) positioned between semi-circumferentially projecting rims 184 and 186. In this non-limiting, exemplary embodiment, snap joints 212 and 214 may be identical.

Snap joints 212 and 214 include identical lugs (or hooks) 222 and 224 that detachably snap fit into respectively a first and a second lateral opening 226 and 228 of first member 104. Inner side surfaces 230 of snap joints 212 and 214 have longitudinally extending stiffeners 232 for providing structural integrity in terms of added strength, while maintaining sufficient flexure for proper operation of snap joints 212 and 214.

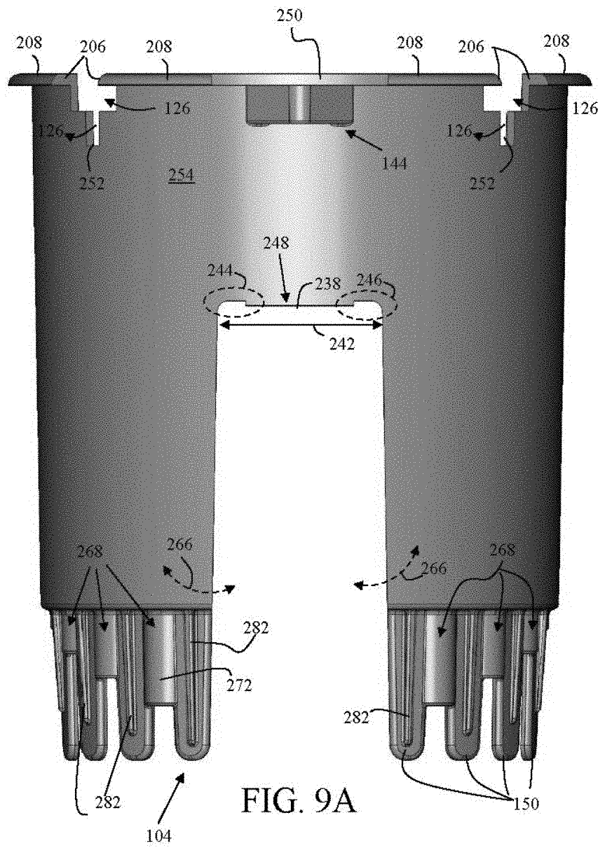

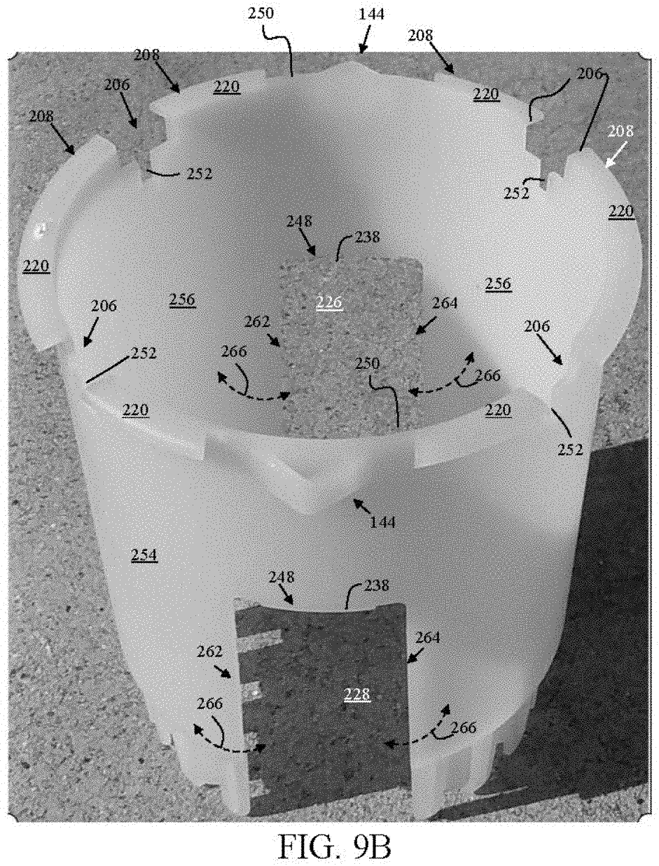

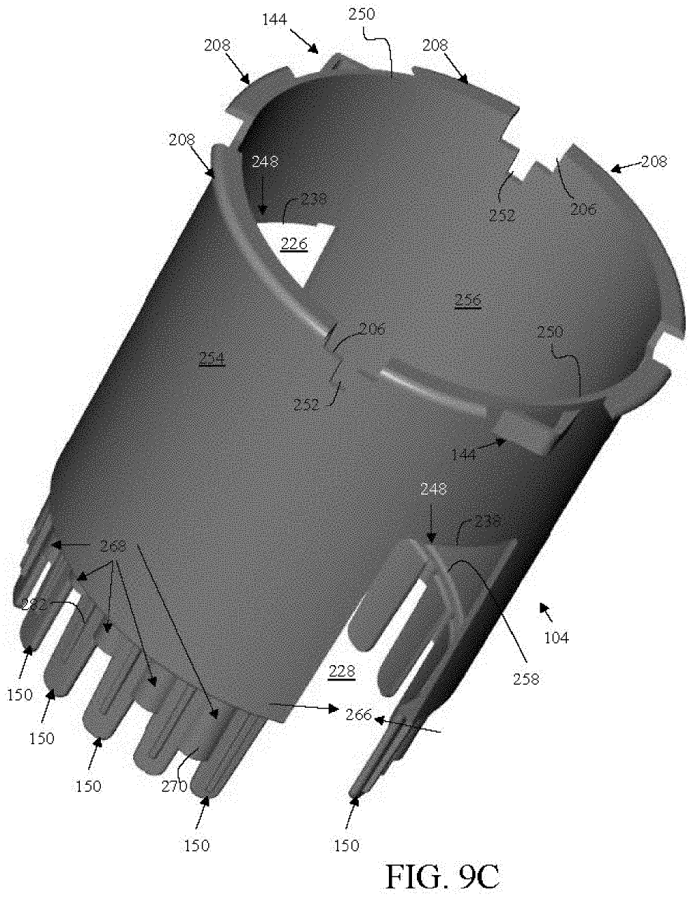

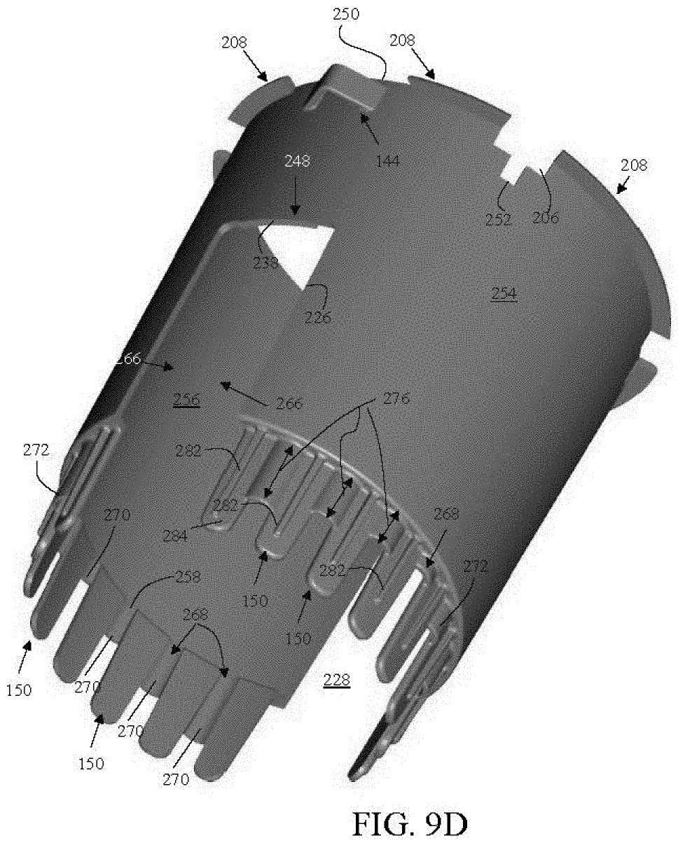

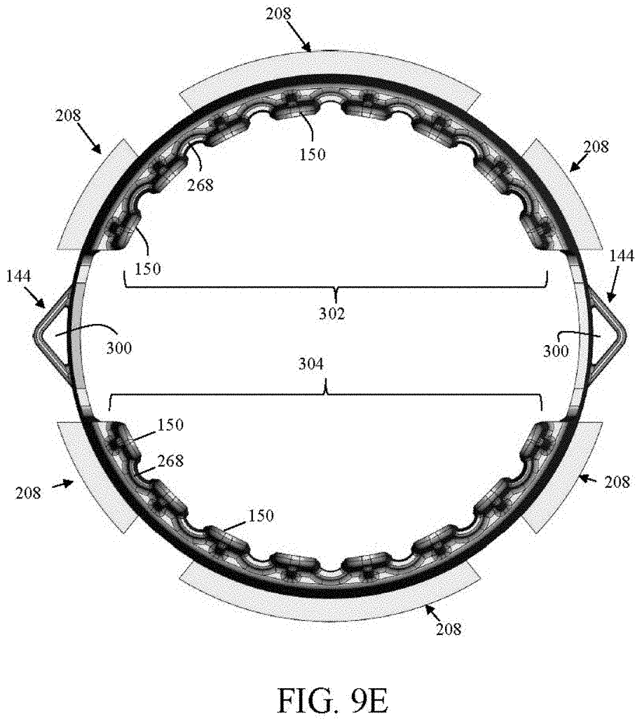

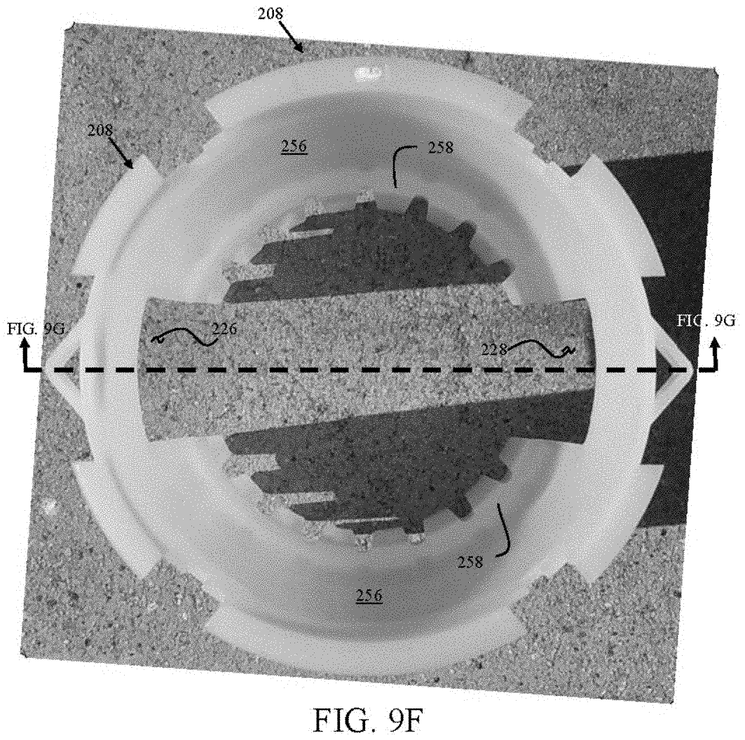

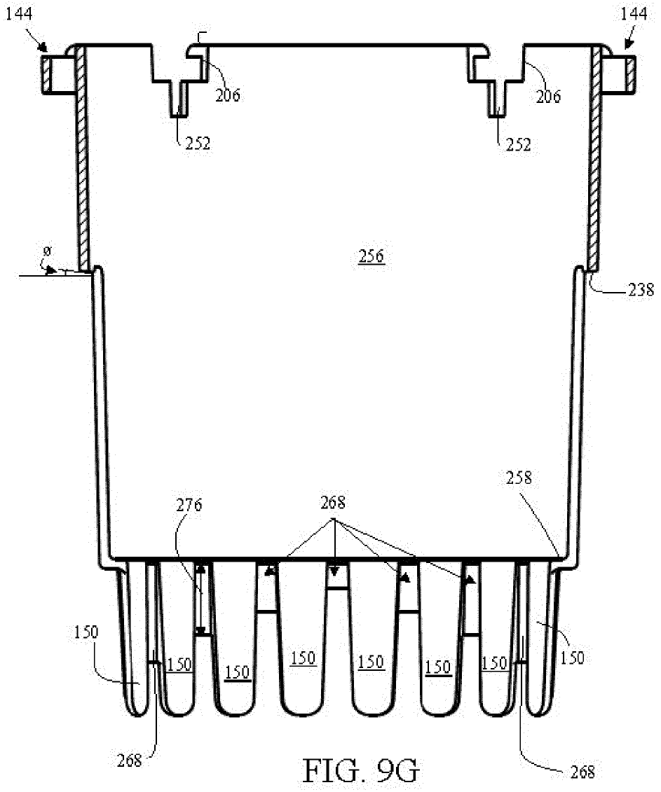

As best shown in FIG. 8G, lugs 222 and 224 include angled (e.g., angle α°) interlock surfaces 234, radially protruding from outer surface 236 of snap joints 212 and 214. Angled interlock surfaces 234 interlock (or hook) with angled (e.g., angle ø° degrees shown in FIG. 9G) surfaces 238 of first sides 248 of first and second lateral openings 226 and 228 of first member 104. Lugs 222 and 224 have narrow arcuate width 240 compared to length span 242 of first sides 238, providing small lateral reliefs 244 and 246 from mid-level 168 water flow 126.

As further illustrated in FIGS. 8H to 8K, cap 102 of device 100 also includes floatation element 122 that is friction-fit within interior cavity 172 of cap 102. In this non-limiting, exemplary instance, floatation element 122 is comprised of one or more removable floatation pieces 122a and 122b. One or more separate floatation pieces 122a and 122b are friction fit within one another as shown (FIGS. 8H to 8L), to form the flotation element 122.

Removing a floatation piece 122a from one or more floatation pieces 122a and 122b (as progressively shown in FIG. 8I to 8K), varies a buoyancy of device 100 to enable use of different weights or amounts of compounds 110. Accordingly, floatation element 122 is adjustable to vary the buoyancy force of device 100. For example, device 100 may remain at or near the bottom for a longer duration for the same amount of compound 110 used if the buoyancy force is adjusted to a lower value. As another example, device 100 may quickly resurface or never sink and simply float for the same amount of compound 110 used if the buoyancy force is adjusted to a higher value.

FIGS. 9A to 9G are non-limiting, exemplary illustrations of the various views of a first member of the compound dispenser device shown in FIGS. 1A to 8K in accordance with one or more embodiments of the present invention. As illustrated, first member 104 of device 100 is comprised of a hollow, generally cylindrical configuration with a top edge 250 that includes a plurality of support flanges 208 in between which are interlocking notches 206. Interlocking notches 206 lead into an (optional) upper flow recess 252 for further enhancing water flow 226. This optional flow recess 252 may be closed off.

Interlocking notches 206 and the optional upper flow recesses 252 comprise the upper openings of device 100 (and first member 104 in particular) and improve flow of dissolved compound 110 from upper section 166 of device 100, with compound released near upper tiles on the side of the pool, if device 100 is floating near the tiles of the pool.

First member 104 of device 100 is further comprised of tie-down member 144 located at an exterior surface 254, near a top edge 250 of first member 104. Tie-down member 144 is comprised of first and second tie-down members 144 positioned diametrically at exterior surface 254, near top edge 250 of first member 104. Accordingly, device 100 includes an integral structure such as tie-down 144 that may be used to tie-down device 100 to a side of a pool to restrict its movement and maintain the device 100 within a certain area.

First member 104 is further comprised of an interior surface 256 that is smooth, but has an inner circumferential stop ledge 258 (near lower interior portion), projecting from interior surface 256. Inner stop ledge 258 engages an outer circumferentially protruded stop ledge 260 of second member 106 to stop the second member 106 from falling out of (or disengaging from) first member 104.

First member 104 of device 100 is further comprised of a first lateral opening 226 and a second lateral opening 228. First and second lateral openings 226 and 228 of first member 104 are comprised of three sides 248, 262, and 264, allowing for transverse flexure 266 of first member 104. In this non-limiting, exemplary embodiment, first and second lateral openings 226 and 228 are identical.

Transverse flexure 266 of first member 104 enables rotational movements 114 and 116 of first and second members 104 and 106 in relation to one another. It should be noted that transverse flexure 266 of first member 104 is pronounced to a greater degree at a lower portion of first member 104.

First and the second lateral openings 226 and 228 of first member 104 provide for a 180° rotational side loading of compound 110. That is, second member 106 may be moved through only 180° degree rotation (rather than a full 360° degrees) to reach one of first and second lateral openings 226 and 228 to define side opening 108 of device 100 for side loading of compound 110.

First member 104 is further comprised of a plurality of dampers 268. Dampers 268 extend longitudinally parallel to longitudinal axis 160 of device 100 from an inner circumferential stop ledge 258 of first member 104. Dampers 268 are connected laterally with damper supports 150.

Dampers 268 have an inner concaved surface 270 and an outer convex surface 272. Inner concaved surface 270 of plurality of dampers 268 function as an interlock relief for receiving an interlocking projection 274 of second member 106 to maintain the rotational position of second member 106 in relation to first member 104. That is, interlocking projections 274 of second member 106 snap into interlock reliefs 270 to maintain the rotational position of second member 106 in relation to first member 104.

As best shown in the sectional view shown in FIG. 9G, longitudinal extensions 276 (i.e., lengths) of dampers 268 differ to vary a flow rate of water into and out of device 100 in relation to a lateral opening 278 of second member 106. In this non-limiting, exemplary instance, first member 104 includes two sets 302 and 304 (FIG. 9E) of symmetrically arranged dampers 268 (with first and second lateral openings 226 and 228 in between the two sets 302 and 304). Middle damper 268 of each set provides the least obstruction (it is the shortest damper), and far end dampers 268 provide the most obstruction (they have the longest span).

As first and second members 104 and 106 rotate in relation to one another, different sized dampers 268 obstruct a lower portion 280 of lateral opening 278 of second member 106 at different levels of obstructions to vary a flow rate of water into and out of device 100. It should be noted that axial motion 164 of first and second members 104 and 106 in relation to one another also moves dampers 268 to vary the obstruction size in relation to the lower portion 280 of lateral opening 278 of second member 106.

As illustrated in the figures, damper supports 150 comprise elongated projections 282 on outer surfaces 284 that function as stiffener to provide structural integrity in terms of add strength for damper supports 150. The rigidity of the damper supports 150 prevent them from bending and hence, from interfering with the movement of second member 106 in relation to first member 104. In this non-limiting, exemplary embodiment damper supports 150 may be of equal length.

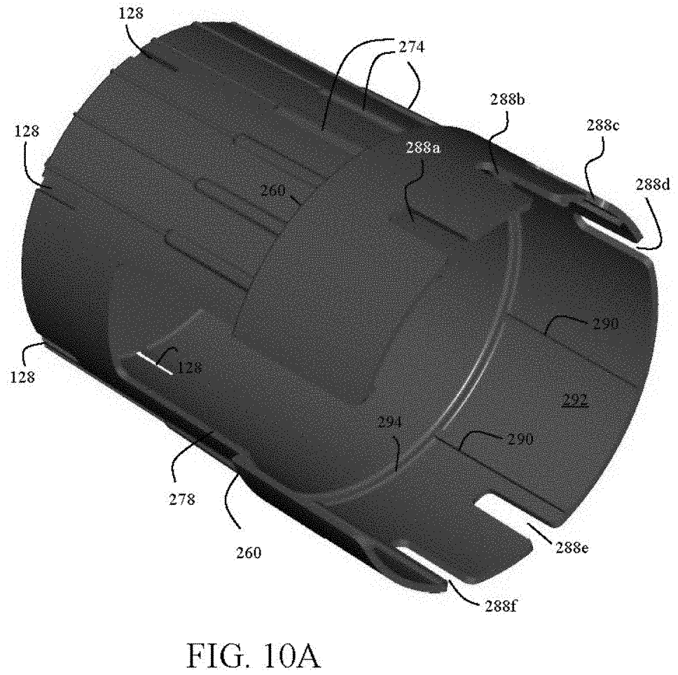

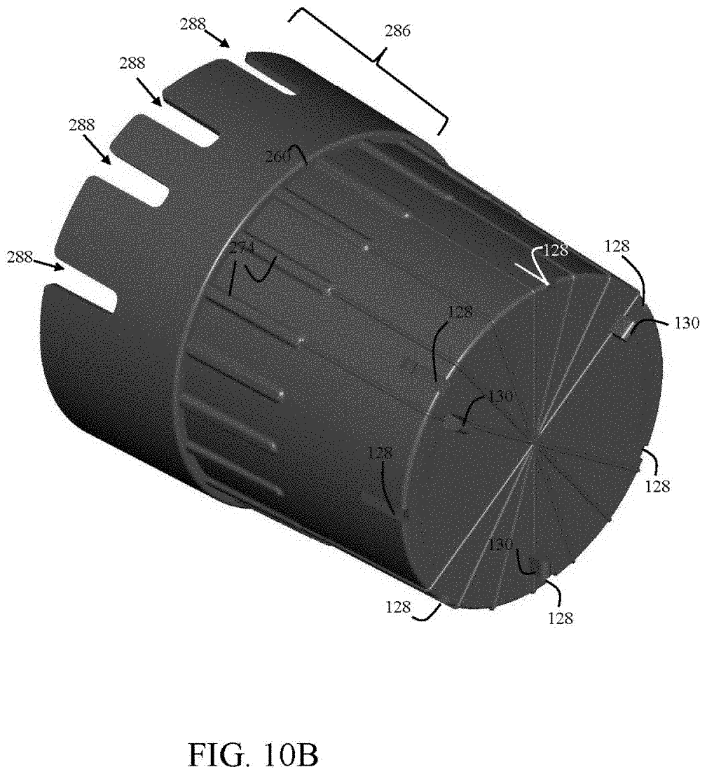

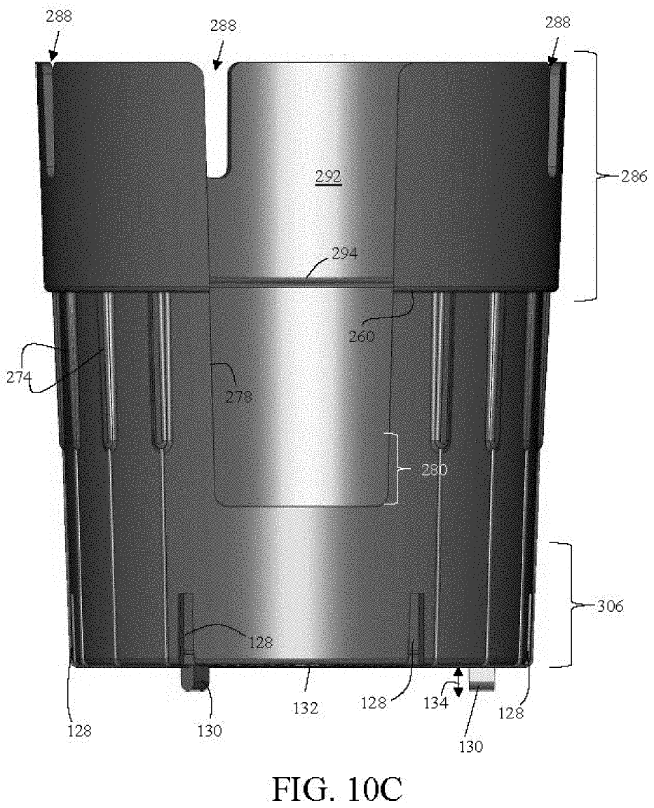

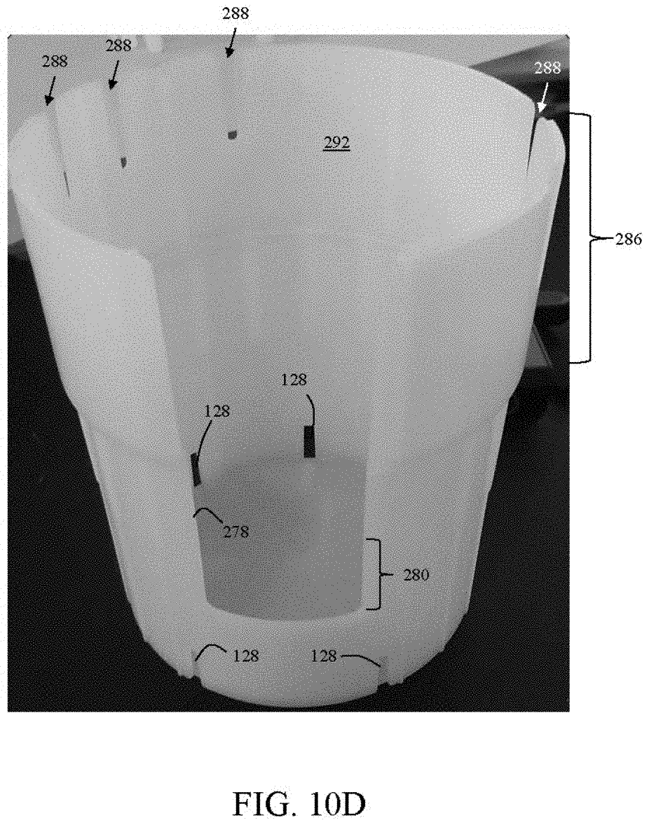

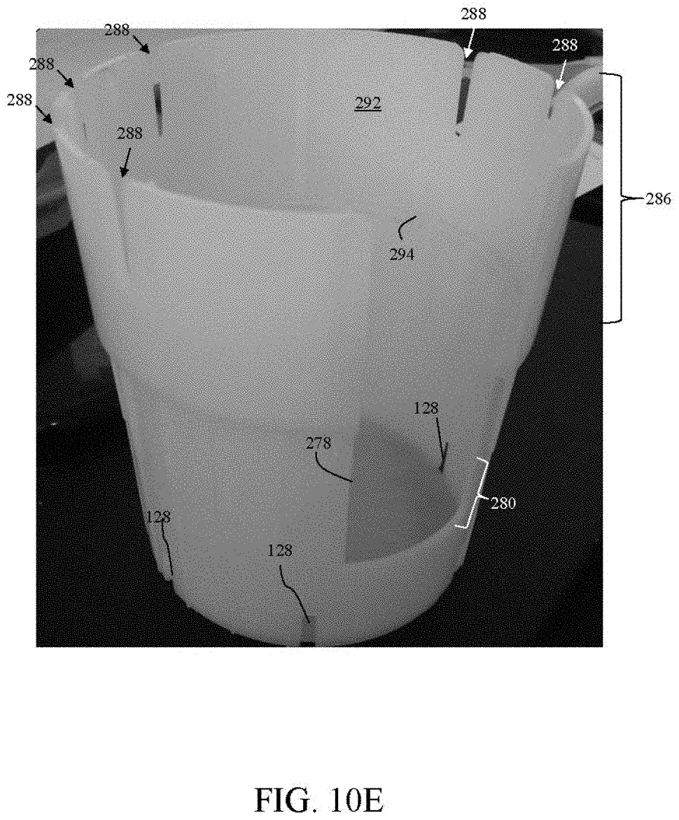

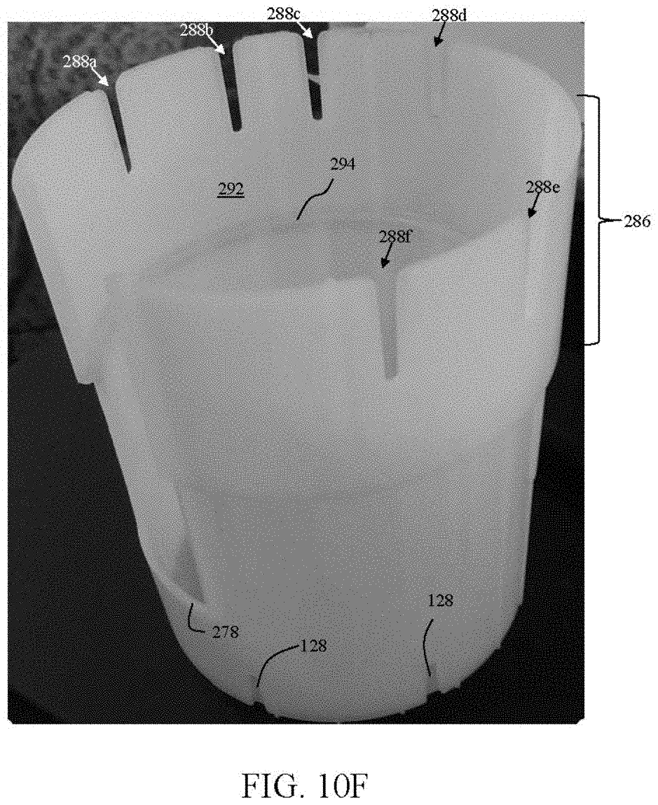

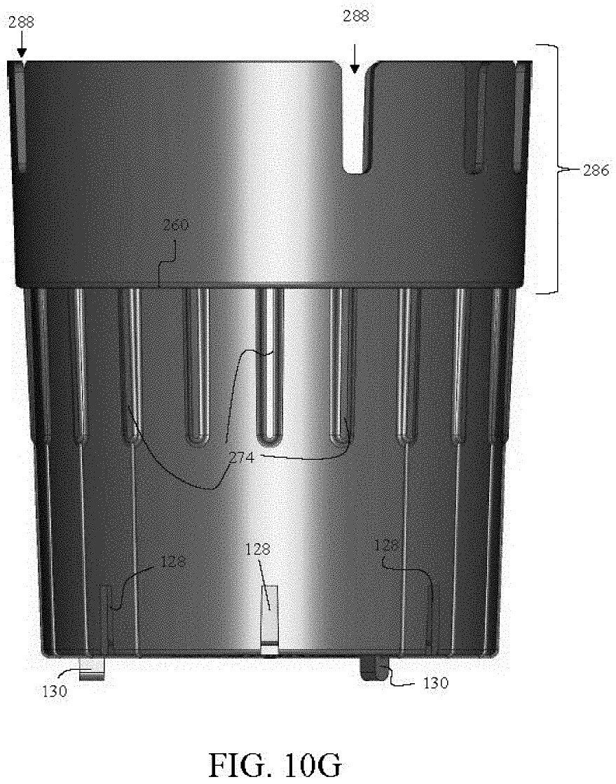

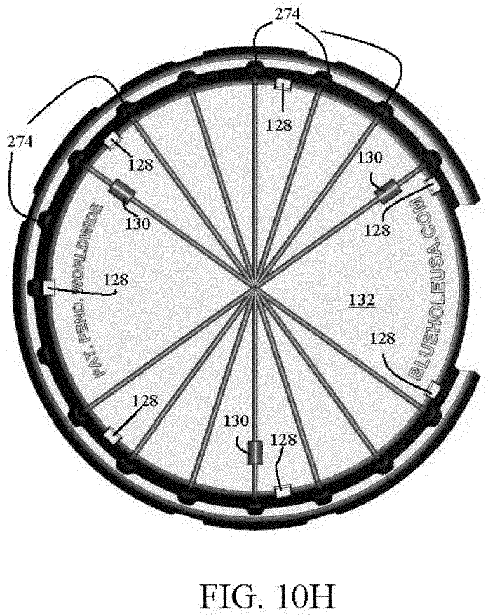

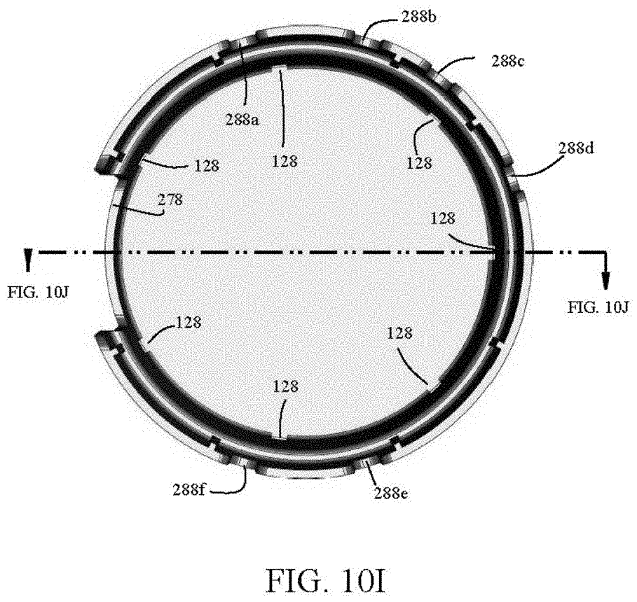

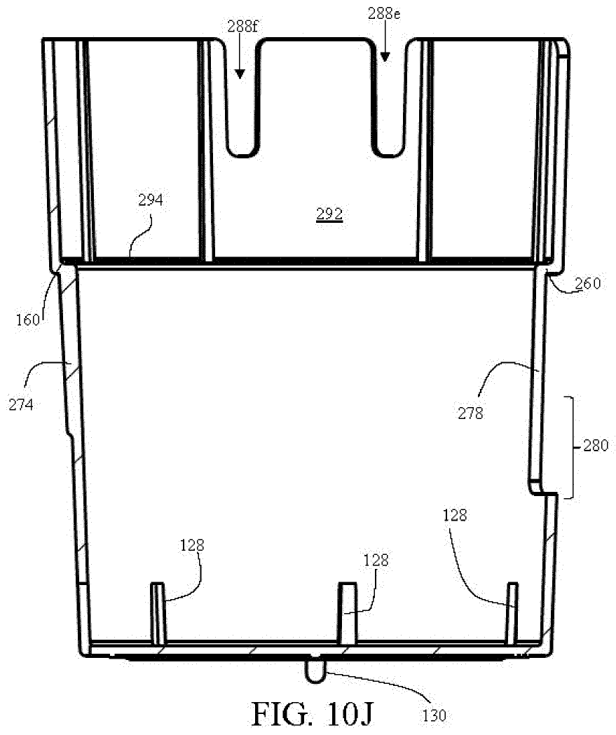

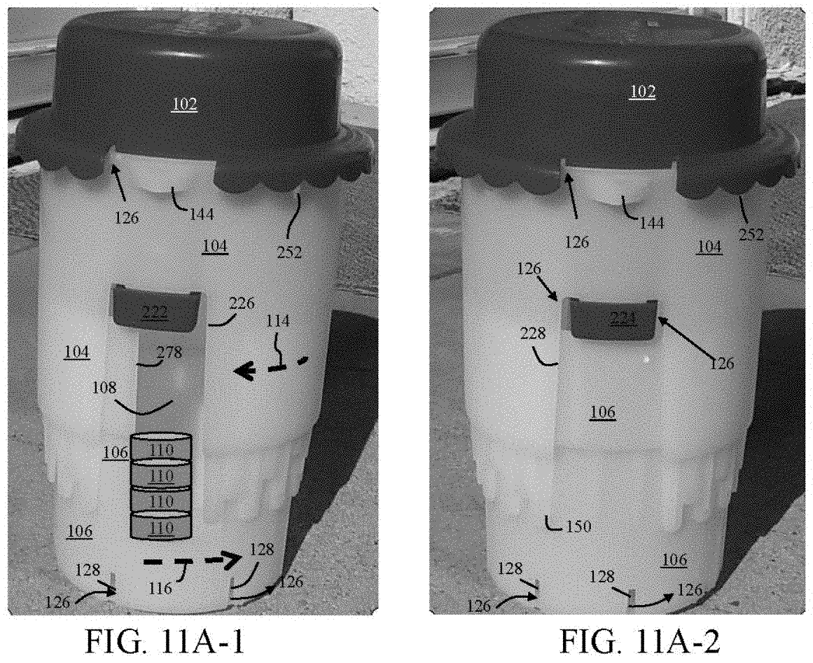

FIGS. 10A to 10J are non-limiting, exemplary illustrations of the various views of a second member of the compound dispenser device shown in FIGS. 1A to 9G in accordance with one or more embodiments of the present invention. As illustrated, second member 106 of device 100 is comprised of lateral opening 278 that when aligned with one of first and second lateral openings 226 and 228 of first member 104, defines side opening 108 of device 100.

Second member 106 further includes an upper portion 286 having plurality of elongated slits 288 (six in total and numbered individually as 228a, 288b, 288c, 288d, 288e, 288f in FIG. 10A) oriented parallel a longitudinal axis 160 of device 100 for added flexure at or near upper portion 286 for facilitating the rotation of first and second members 104 and 106 in relation to one another. It should be noted that slits 288 may be varied in size and need not be uniformly sized as shown.

Plurality of elongated slits 288 are positioned asymmetrically along upper portion 286 and also function as mid-vents to control a rate of flow 126 of water through mid-portion 168 of device 100 in cooperation with plurality of dampers 268 of first member 104 (further detailed below) as first and second members 104 and 106 are moved in relation to one another. Accordingly, multi-level varying vents are provided to vary rate of flow 126 of water at different levels of device 100 and at different water elevations.

As further illustrated, elongated stiffeners 290 are positioned parallel along longitudinal axis 160 of device 100, along interior surface 292 of upper portion 286 of second member 106 for added rigidity. Interior surface 292 is comprised of an interior circumferential ledge 294, which defines outer circumferentially protruded stop edge 260 of second member 106 to stop second member 106 from falling out of (or disengage from) first member 104.

Second member 106 is further comprised of interlocking projections 274 that engage dampers 268 on first member 104 to maintain positions of first and second members 104 and 106 in relation to one another.

Second member 106 is further comprised of a plurality of bottom openings 128 that are positioned around a bottom portion 306 of second member 106, optionally equally distanced from one another. Stands (or supports) 130 projecting from an exterior bottom surface 132 raise a bottom 132 of second member 106 off of pool floor 124 at a height 134, allowing for proper flow (or current) 136 between bottom 132 of second member 106 and pool floor 124 for dispersion of compound 110 as dissolved compound 110 egresses from bottom openings 128. This added current flow 136 does not allow concentrated dissolved compound 110 to linger for too long at bottom 132 of device 100, preventing potential damage to the pool plaster (as an example).

FIGS. 11A-1 to 11H-2 are non-limiting, exemplary illustrations of the various views of the compound dispenser device shown in FIGS. 1A to 10J, progressively illustrating the working cooperative relationship between various openings as first and second members are rotated when compound dispenser device is in a fully extended (or protracted) position in accordance with one or more embodiments of the present invention. All of the details below equally apply to both float mode and sink mode use of device 100.

In particular, working cooperative relationships are illustrated in FIGS. 11A-1 to 11H-2 for slits 288 of second member 106 in relations to first and second lateral openings 226 and 228 of first member 104 in view of damper 268 (and damper support 150) obstructions in relation to lateral opening 278 of second member 106. It should be noted that there is always water flow 126 through upper openings (206 and 252) and bottom openings 128 as they are not blocked or obstructed. Ingress or egress water flows for a few exemplary openings are shown by arrows 126 in FIGS. 11A-1 to 11H-2.

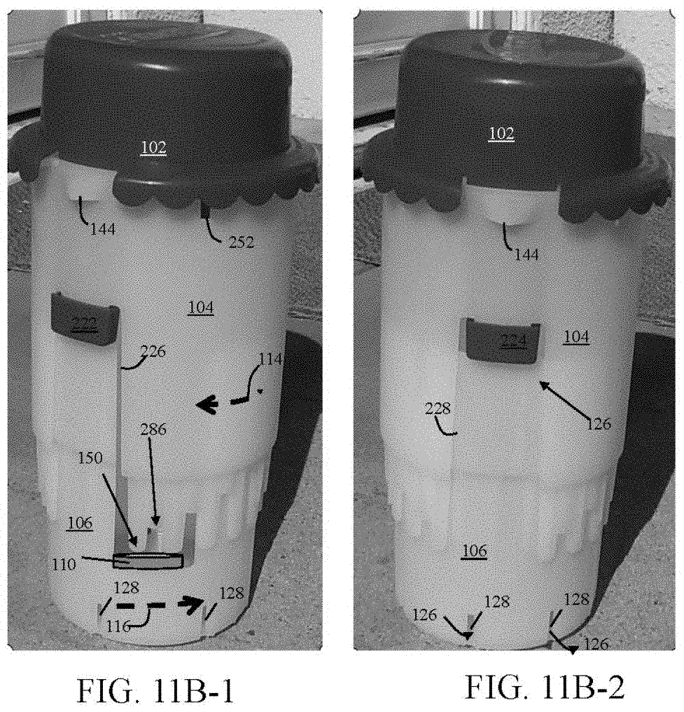

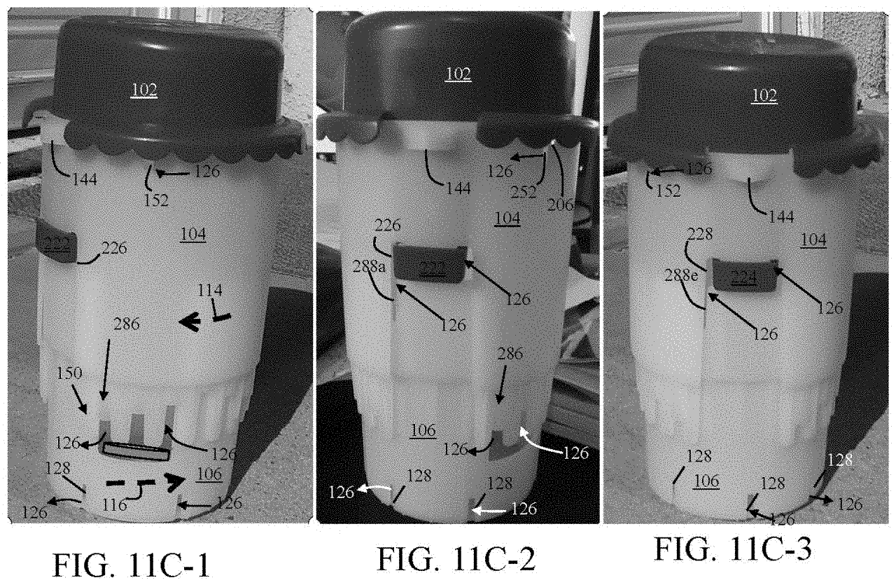

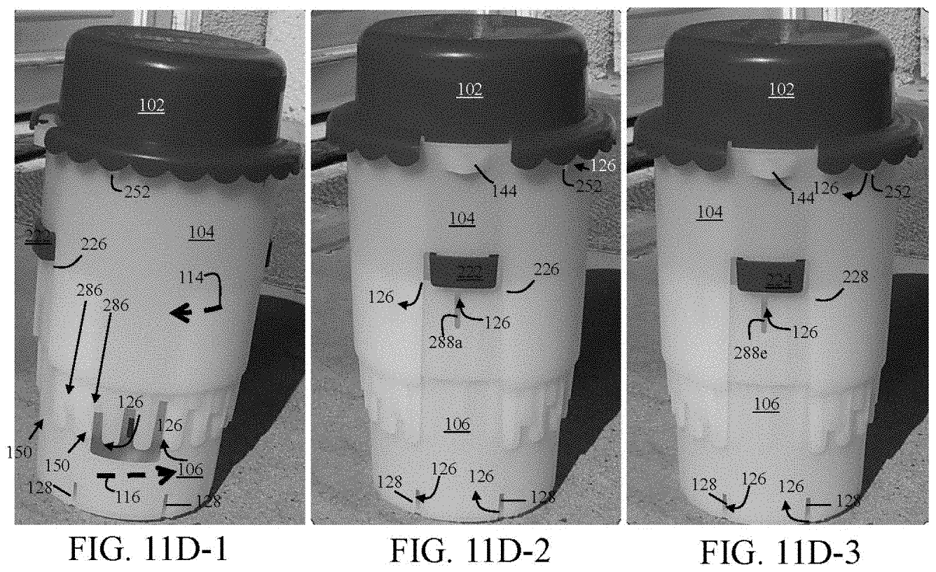

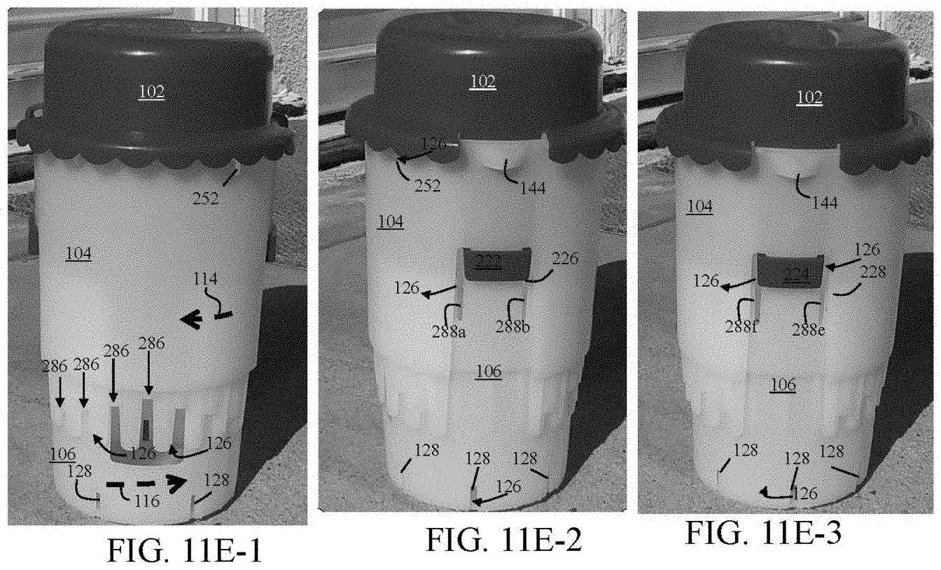

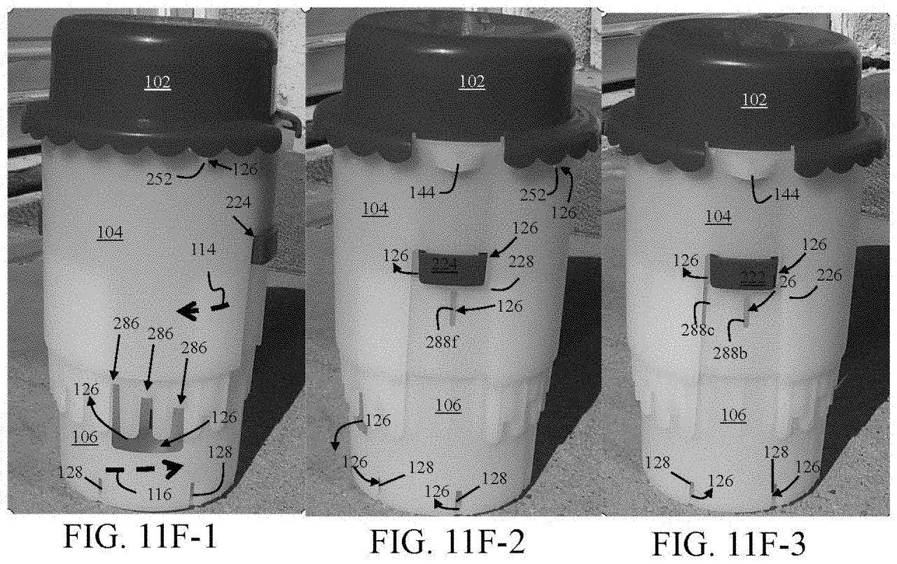

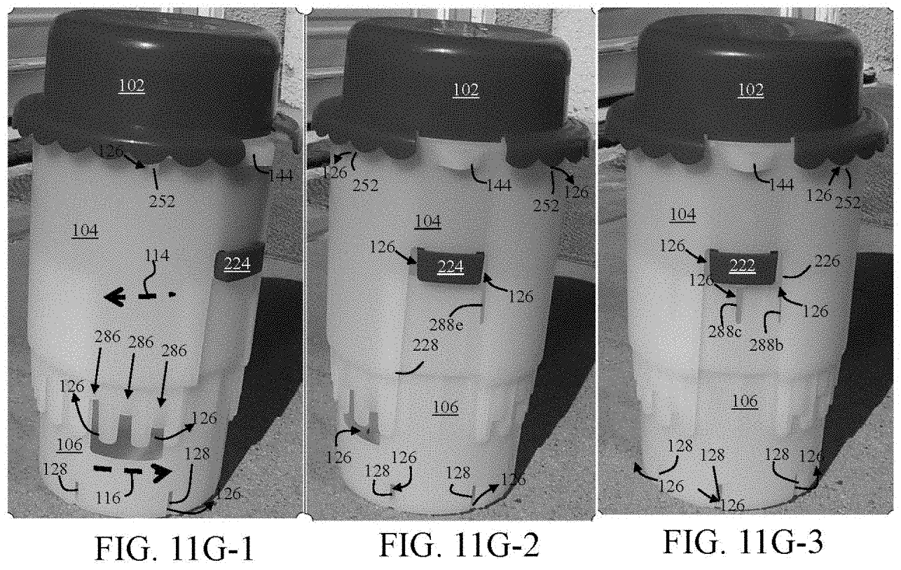

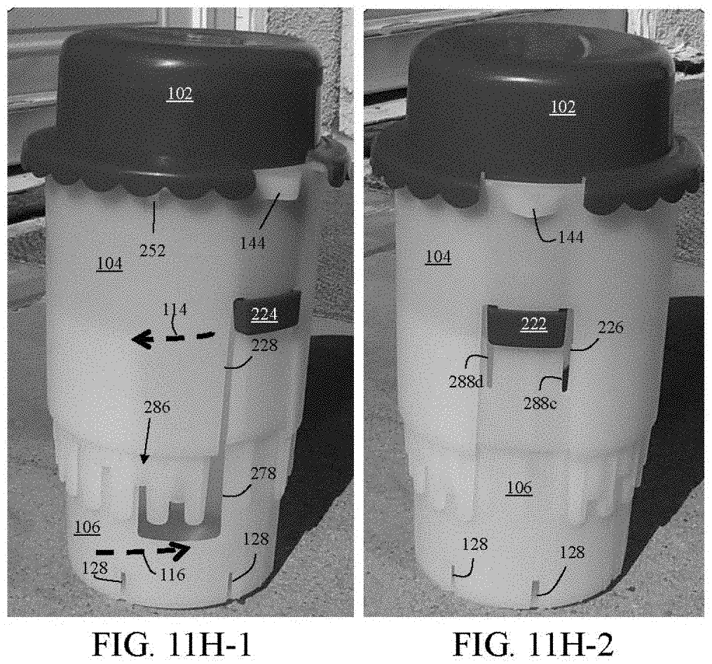

FIGS. 11A-1 and 11A-2 are non-limiting, exemplary illustrations of device 100 with compounds 110 side-loaded and first and second members 104 and 106 being rotated in relation to one another as shown by respective arrows 114 and 116. FIG. 11A-2 shows the opposite side of device 100 in the same position of first and second members 104 and 106 illustrated in FIG. 11A-1.

FIGS. 11B-1 and 11B-2 are non-limiting, exemplary illustrations of device 100 with first and second members 104 and 106 further rotated in relation to one another (as shown by respective arrows 114 and 116) to a position where lateral opening 278 is almost closed off. FIG. 11B-2 shows the opposite side of device 100 in the exact position of first and second members 104 and 106 as illustrated in FIG. 11B-1.

FIGS. 11C-1 to 11C-3 are non-limiting, exemplary illustrations of device 100 with first and second members 104 and 106 rotated in relation to one another (as shown by respective arrows 114 and 116) to a position where first damper 268 is over lower portion 280 of lateral opening 278 of second member 106. FIGS. 11C-2 and 11C-3 show different side views of device 100 in the same positions of first and second members 104 and 106 illustrated in FIG. 11C-1.

As illustrated in FIG. 11C-2, at this stage, slit 288a of second member 106 is within first lateral opening 226 of first member 104, and as shown in FIG. 11C-3, slit 288e of second member 106 is within second lateral opening 228 of first member 104, enabling further water flow 126 at mid-section 168 of device 100 in relation to one another and flows 126 of lower portion's 280 opening 278 of second member 106 as shown in FIG. 11C-1.

FIGS. 11D-1 to 11D-3 are non-limiting, exemplary illustrations of device 100 with first and second members 104 and 106 further rotated in relation to one another (as shown by respective arrows 114 and 116) to a position where second damper 268 is now over lower portion 280 of lateral opening 278 of second member 106. FIGS. 11D-2 and 11D-3 show different side views of device 100 in the same positions of first and second members 104 and 106 as illustrated in FIG. 11D-1.

As illustrated in FIGS. 11D-1 to 11D-3, third and subsequent dampers 268 over lower portion 280 of lateral opening 278 of second member 106 have shorter lengths 276 and hence, enable greater rate of flow 126 of water through lower portion 280 of lateral opening 278.

As illustrated in FIG. 11D-2, at this stage, slit 288a of second member 106 is within first lateral opening 226 of first member 104 and, as shown in FIG. 11D-3, slit 288e of second member 106 is now within second lateral opening 228, enabling further water flow 126 at mid-section 168 of device 100 in relation to one another and flows 126 through lower portion 280 opening 278 of second member 106 as shown in FIG. 11D-1.

FIGS. 11E-1 to 11E-3 are non-limiting, exemplary illustrations of device 100 with first and second members 104 and 106 further rotated in relation to one another (as shown by respective arrows 114 and 116) to a position where third damper 268 is now over lower portion 280 of lateral opening 278 of second member 106. FIGS. 11E-2 and 11E-3 show different side views of device 100 in the same positions of first and second members 104 and 106 as illustrated in FIG. 11E-1.

As illustrated in FIGS. 11E-1 to 11E-3, a fourth damper 268 over lower portion 280 of lateral opening 278 of second member 106 has the shortest length 276 and hence, enables greater rate of flow 126 of water through lower portion 280 of lateral opening 278.

As illustrated in FIG. 11E-2, at this stage, slits 288a and 288b of second member 106 are within first lateral opening 226 of first member 104 and as shown in FIG. 11E-3, slits 288f and 288e of second member 106 are within second lateral opening 228 of first member 104, enabling further water flow 126 at mid-section 168 of device 100 in relation to one another and flows 126 of lower portion 280 opening 278 of second member 106 as shown in FIG. 11E-1.

FIGS. 11F-1 to 11F-3 are non-limiting, exemplary illustrations of device 100 with first and second member 104 and 106 further rotated in relation to one another (as shown by respective arrows 114 and 116) to a position where fourth damper 268 (shortest damper) is now over lower portion 280 of lateral opening 278 of second member 106. FIGS. 11F-2 and 11F-3 show different side views of device 100 in the exact positions of first and second members 104 and 106 as illustrated in FIG. 11F-1.

As illustrated in FIGS. 11F-1 to 11F-3, fifth and subsequent dampers 268 over lower portion 280 of lateral opening 278 of second member 106 have progressively longer lengths 276 and hence, enable lesser rate of flow 126 of water through lower portion 280 of lateral opening 278.

As illustrated in FIG. 11F-2, at this stage, slit 288f of second member 106 is within second lateral opening 228 of first member 104 and as shown in FIG. 11F-3, slit 288c and 288b of second member 106 are within first lateral opening 226, enabling further water flow 126 at mid-section 168 of device 100 in relation to one another and flows 126 of lower portion 280 opening 278 of second member 106 as shown in FIG. 11F-1.

FIGS. 11G-1 to 11G-3 are non-limiting, exemplary illustrations of device 100 with first and second members 104 and 106 further rotated in relation to one another (as shown by respective arrows 114 and 116) to a position where fifth damper 268 is now over lower portion 280 of lateral opening 278 of second member 106. FIGS. 11G-2 and 11G-3 show different side views of device 100 in the same positions of first and second members 104 and 106 illustrated in FIG. 11G-1.

As illustrated in FIGS. 11G-1 to 11G-3, sixth and subsequent dampers 268 over lower portion 280 of lateral opening 278 of second member 106 have longer and longer lengths 276 and hence, enable lesser rates of flow 126 of water through lower portion 280 of lateral opening 278.

As illustrated in FIG. 11G-2, at this stage, slit 288e of second member 106 is within second lateral opening 228 of first member 104 and as shown in FIG. 110-3, slits 228c and 288b of second member 106 are within first lateral opening 226, enabling further water flow 126 at mid-section 168 of device 100 in relation to one another and flows 126 of lower portion 280 of lateral opening 278 of second member 106 as shown in FIG. 11G-1.

FIGS. 11H-1 and 11H-2 are non-limiting, exemplary illustrations of device 100 with first and second members 104 and 106 further rotated in relation to one another (as shown by respective arrows 114 and 116) to a position where sixth damper 268 is now over lower portion 280 of lateral opening 278 of second member 106. FIG. 11H-2 shows a different side views of device 100 in the exact positions of first and second members 104 and 106 as illustrated in FIG. 11H-1. At the illustrated stage, lateral opening 278 of second member 106 has now reached second lateral opening 228 of first member 104.

As illustrated in FIG. 11H-2, at this stage, slits 288d and 288c of second member 106 are fully within first lateral opening 226 of first member 104, enabling further water flow 126 at mid-section 168 of device 100 in relation to one another and flows 126 of lower portion 280 of lateral opening 278 of second member 106 as shown in FIG. 11H-1.

As best illustrated in FIG. 11H-1, any further rotations of first and second members 104 and 106 would complete a 180° degree rotation, which would align second lateral opening 228 of first member 104 with lateral opening 278 of second member, defining side opening 108. This defined opening would be at 180° degrees opposite of the illustrated side opening 108 defined by first lateral opening 226 of first member 104 when aligned with lateral opening 278 of second member 106 as shown in FIG. 11A-1. Accordingly, side opening 108 may be achieved by aligning lateral opening 278 of second member 106 with either first or second lateral openings 226 or 228 of first member 104.

In view of above, device 100 is provided with multiple openings or vents at different elevations and positions so that any slight movement of water in or around device 100 provides a maximum efficient flow and circulation of water through device 100 for efficient dispersion of dissolved compound 110 at multiple levels of device 100 and different elevations (for example, depths) of water.

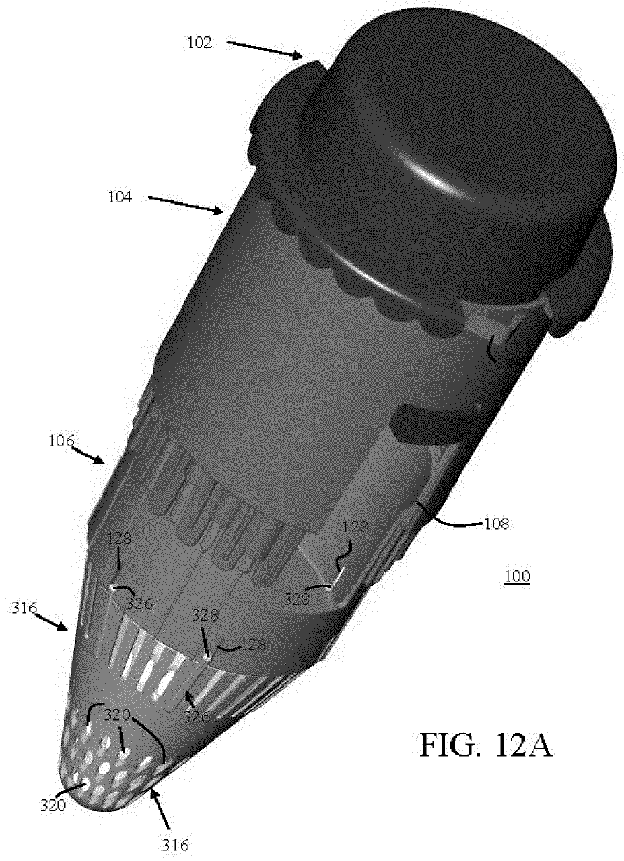

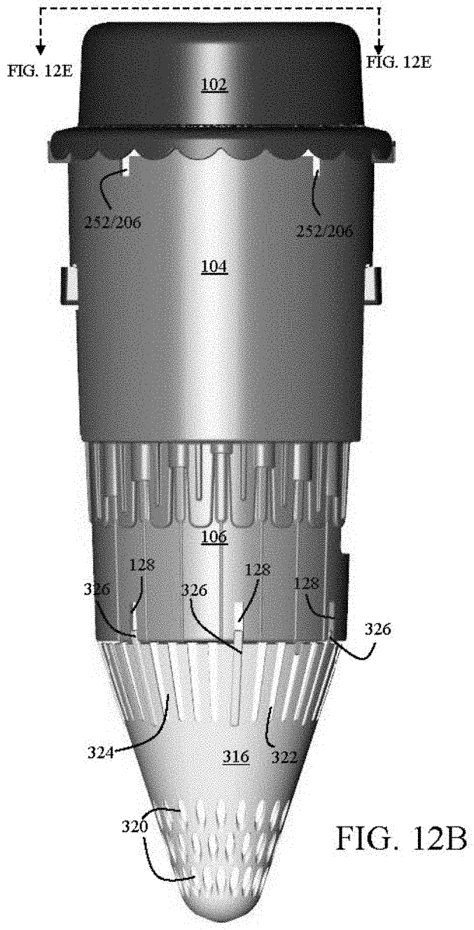

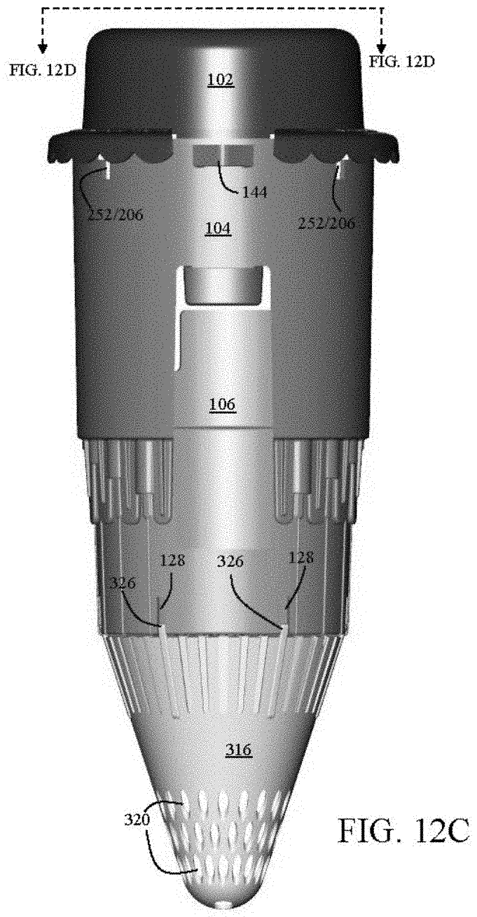

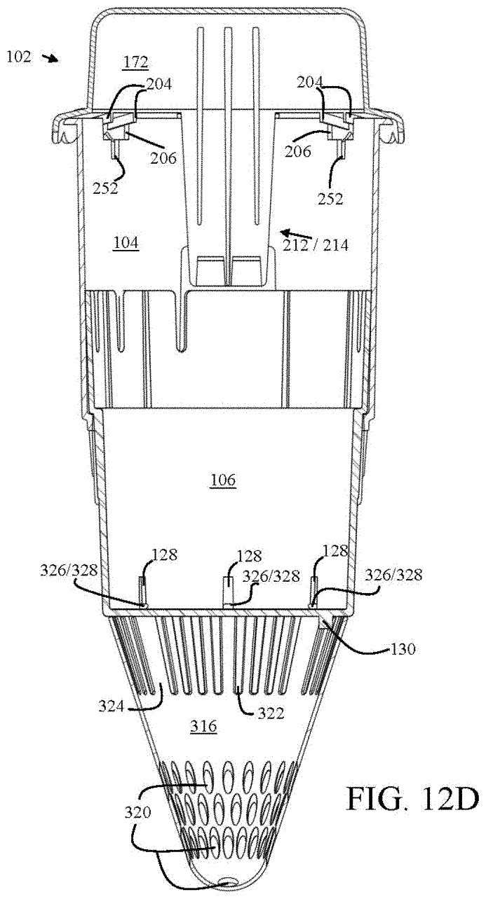

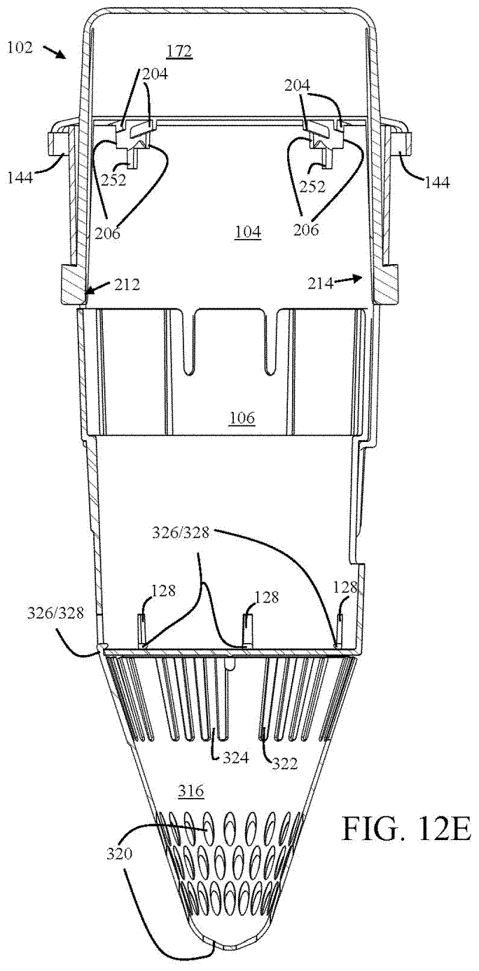

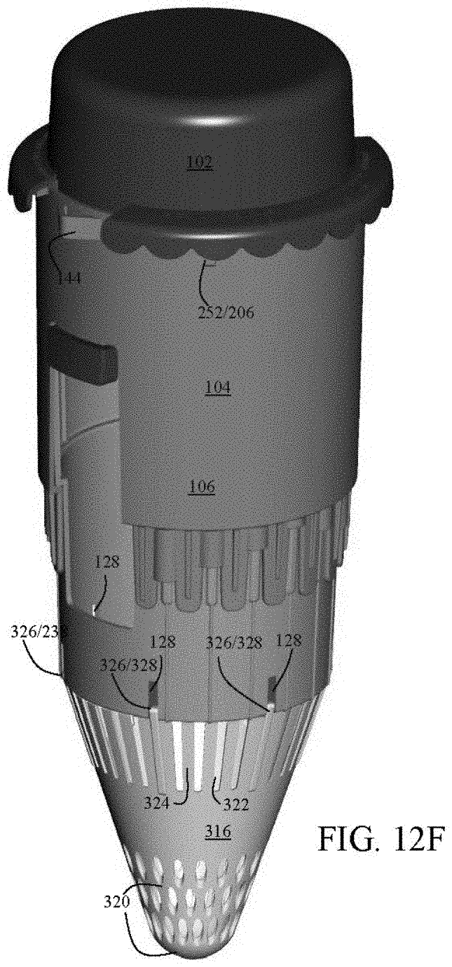

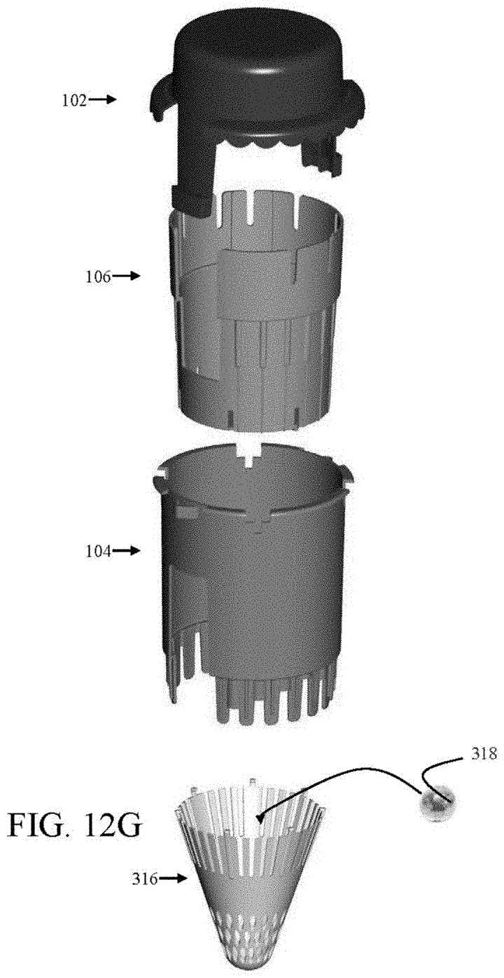

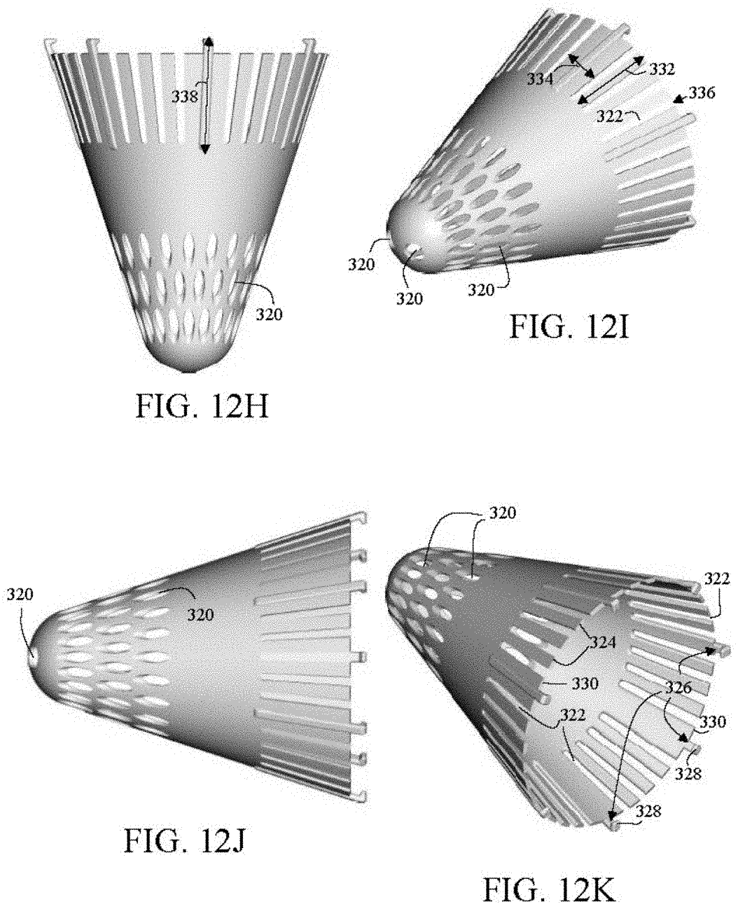

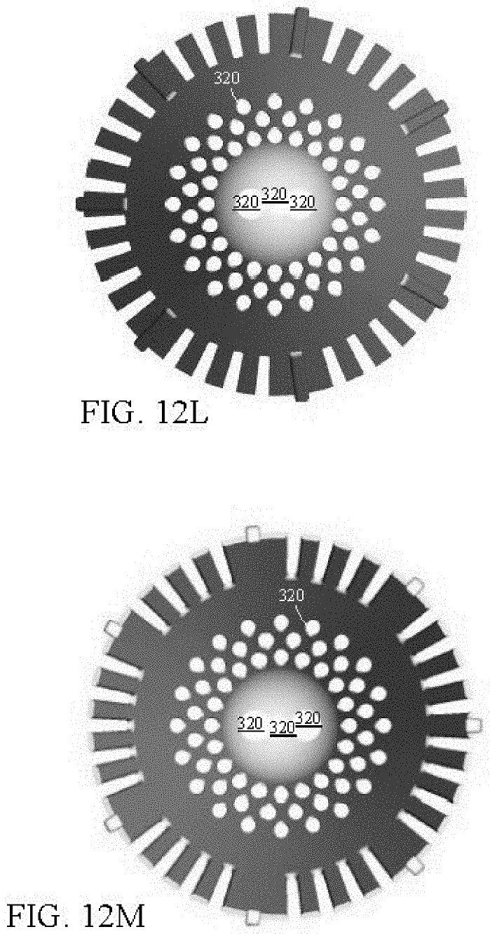

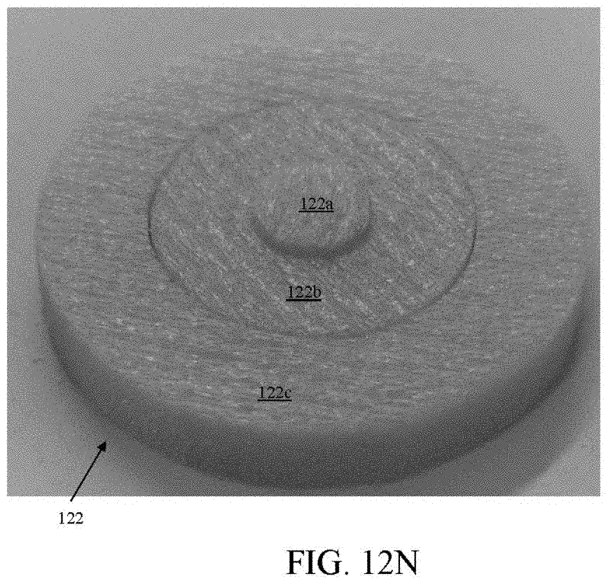

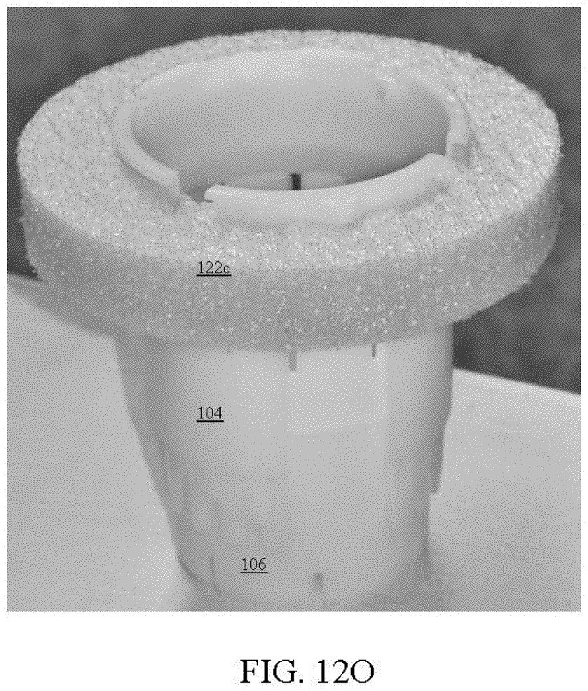

FIGS. 12A to 12O are non-limiting, exemplary illustrations of a compound dispenser device shown in FIGS. 1A to 11H-2, with an added holder for anti-electrolysis anode element in accordance with another embodiment of the present invention. FIG. 12L is non-limiting, exemplary illustrations of the exterior of the holder viewed from the bottom, while FIG. 12M illustrates the interior of the holder viewed from the top. Device 100 illustrated in FIGS. 12A to 12O includes similar corresponding or equivalent components, interconnections, functional, operational, and or cooperative relationships as device 100 that is shown in FIGS. 1A to 11H-2, and described above. Therefore, for the sake of brevity, clarity, convenience, and to avoid duplication, the general description of FIGS. 1A to 11H-1 will not repeat every corresponding or equivalent component, interconnections, functional, operational, and or cooperative relationships that has already been described above in relation to device 100 that is shown in FIGS. 1A to 11H-2 but instead, are incorporated by reference herein.

As illustrated in FIGS. 12A to 12O, in this non-limiting, exemplary embodiment device 100 includes an optional holder 316 that may be used to hold one or more anti-electrolysis anode element 318 such as zinc, which are extensively used for salt-water pools. Zinc based anode anti-electrolysis zinc elements (or alloys thereof) are well known.

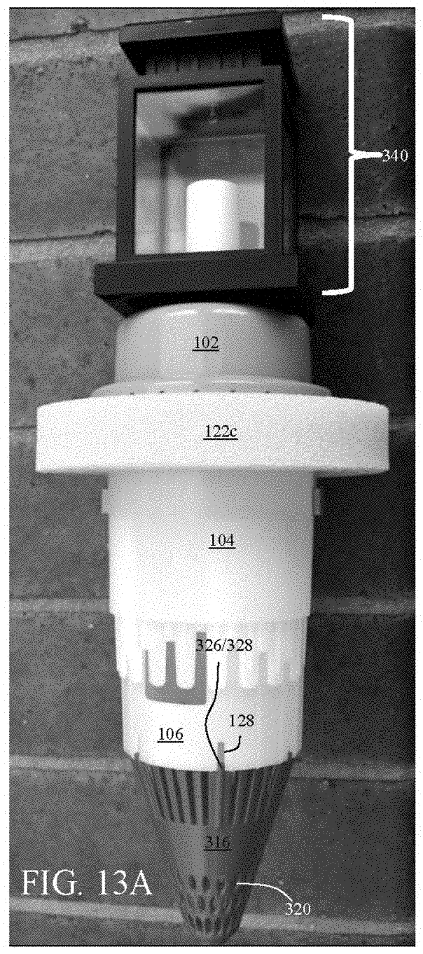

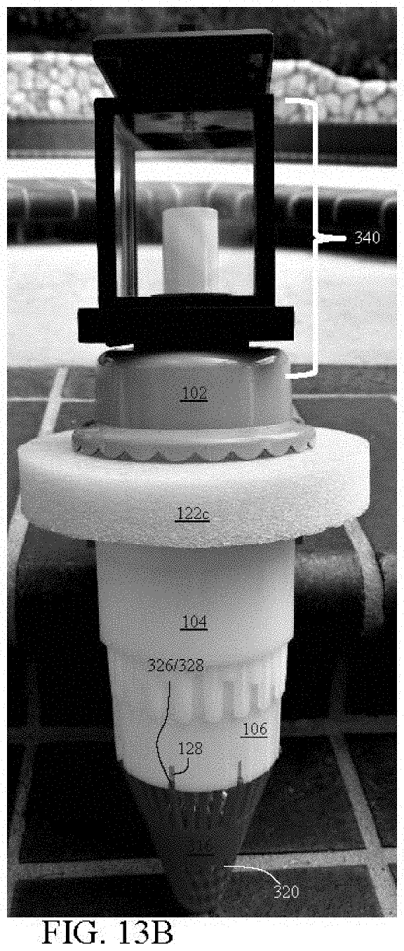

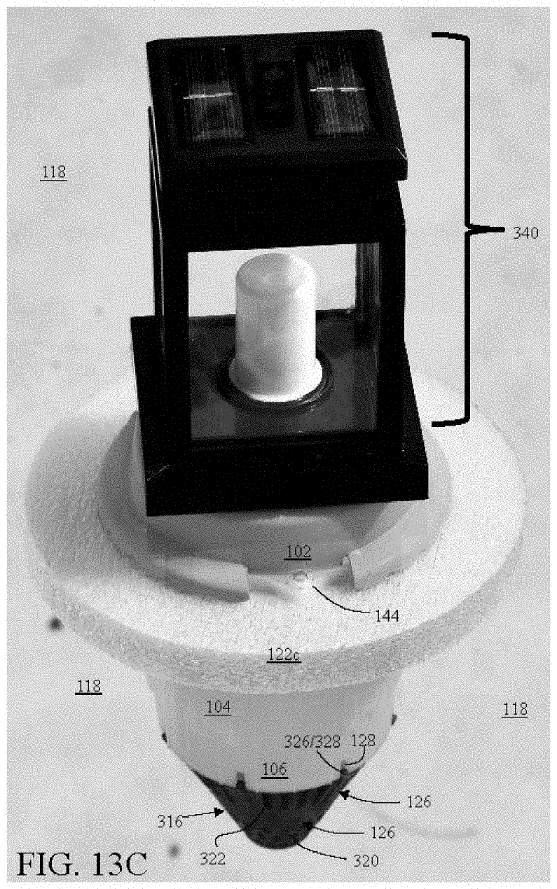

The entire device 100 (with holder 316 and anti-electrolysis element 318) may either be used in sink mode or float mode operations, and further, may be used either in collapsed or extended position. If float mode operation is desired, an added external floatation element 122c (best shown in FIGS. 12N and 12O) may be used in addition to floatation elements 122a and 122b within cap 102, which will function as a counter-weight against the added weight due to holder 316 and anti-electrolysis element 138. It should be noted that the amount anti-electrolysis element 138 used may also be varied to vary floatation of device 100. As illustrated, floatation element 122c has an annular shape with an inner diameter opening that may easily receive and engage with first member 104 of device 100. Use of floatation element 122c are also shown in the next embodiment illustrated in FIGS. 13A to 13C.

Holder 316 has a general cone configuration, with a wider diameter top side that engages second member 106 of device 100 and a narrower diameter bottom side with flow openings 320. Holder 316 has a plurality of flow openings 320 through which water flows, interacting with anti-electrolysis element 318 stored within holder 316.

Holder 316 further includes a plurality of elongated diverging radial flexor slits 322 formed in between a plurality of elongated diverging radial stiffeners 324, with flexor slits 322 enabling holder 316 to be flexible for detachably mounting onto device 100. It should be noted that water may also flow through flexor slits 322. The overall height 332 of stiffeners 324 may be uniform, but the overall width 334 thereof may vary. However, the overall width 336 of flexor slits 322 may be uniform.

Holder 316 further includes a set of latching projections 326 that engage bottom openings 128 of second member 106 of device 100. In particular, latching projections 326 have an angled engagement end 328 that are inserted into and snap in position within bottom openings 128. The engagement ends 328 may have chamfered edges for easy insertion or snapping within bottom openings 128. As illustrated, latching projections 326 extend out from top edge 330 of the plurality of stiffeners 324, however, their overall length 338 extends height 332 of stiffeners 324 for added strength for the particular stiffeners 324 that include latching projection 326.

FIGS. 13A to 13C are non-limiting, exemplary illustrations of a compound dispenser device shown in FIGS. 1A to 12O, with an added well known, conventional lantern for lighting and aesthetics in accordance with another embodiment of the present invention. Device 100 illustrated in FIGS. 13A to 13C includes similar corresponding or equivalent components, interconnections, functional, operational, and or cooperative relationships as device 100 that is shown in FIGS. 1A to 12O, and described above. Therefore, for the sake of brevity, clarity, convenience, and to avoid duplication, the general description of FIGS. 1A to 12O will not repeat every corresponding or equivalent component, interconnections, functional, operational, and or cooperative relationships that has already been described above in relation to device 100 that is shown in FIGS. 1A to 12O but instead, are incorporated by reference herein.

As illustrated in FIGS. 13A to 13C, in this non-limiting, exemplary embodiment, device 100 includes a well-known conventional electronic lantern 340 that is attached on top surface 194 of cap 102 by a well-known, conventional double-sided adhesive tape. Device 100 with lantern 340 is used in float mode operations and hence, the need for the added external floatation element 122c as shown.

It should be noted that use of lantern 340 may make device 100 top heavy, making device 100 potentially prone to tilting. However, using additional anti-electrolysis elements 318 within holder 316 will function as a counter-weight balance, lower the overall center of gravity of device 100, making the float mode operation of device 100 very stable while floating on water as shown in FIG. 13C.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. For example, the sizes of the floating device, holder, etc. including its individual components may be varied. Such variations and alternate embodiments are contemplated, and can be made without departing from the spirit and scope of the invention.

It should further be noted that, throughout the entire disclosure, the labels such as left, right, front, back, top, inside, outside, bottom, forward, reverse, clockwise, counter clockwise, up, down, or other similar terms such as upper, lower, aft, fore, vertical, horizontal, lateral, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure is not used to show a serial or numerical limitation but instead is used to distinguish or identify the various members of the group.

Further the terms “a” and “an” throughout the disclosure (and in particular, claims) do not denote a limitation of quantity, but rather denote the presence of at least one of the referenced item.

The use of the phrases “and or,” “and/or” throughout the specification (if any used) indicate an inclusive “or” where for example, A and or B should be interpreted as “A,” “B,” or both “A and B.”

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A device for dispensing a compound, comprising:
a first member that includes a first opening on a side of the first member;
a second member that includes a second opening on a side of the second member;
wherein: the first opening and the second opening when aligned define a side opening of the device;
wherein: the compound is side loaded through the side opening of the device.

2. The device for dispensing a compound as set forth in claim 1 wherein:
the first member and the second member are moveably associated with one another.

3. The device for dispensing a compound as set forth in claim 1, wherein:
the first member and the second member are axially and rotatably associated with one another;
wherein: the first and the second members move axially along a central longitudinal axis of the device, to telescopically move to one of a retracted position and a protracted position of the device; and
wherein: the first and the second members rotate about the central longitudinal axis of the device.

4. The device for dispensing a compound as set forth in claim 1, wherein:
the first member and the second member define various openings of the device along an upper section, a general middle section, and a lower section of the device for flow of water through the device at different water level depths.

5. The device for dispensing a compound as set forth in claim 4, wherein:
openings at the general middle section of the device vary in size.

6. A device for dispensing a compound, comprising:
a cap;
a first member, with the cap detachably associated with the first member;
a second member moveably associated with the first member;
the first and the second members define a side opening of the device that varies in size as the first and the second members move;
wherein: the compound is side loaded into the device without removing the cap through the side opening or top-loaded by removing the cap.

7. The device for dispensing a compound as set forth in claim 6, further comprising:
a floatation element removably associated with the device.

8. The device for dispensing a compound as set forth in claim 6, further comprising:
a floatation element removably associated with the cap.

9. The device for dispensing a compound as set forth in claim 7, wherein:
the side-loading of a maximum amount of the compound submerges the device, and as the compound is continuously dissolved and depleted, the device is commensurately moved towards water surface and resurfaces above water.

10. The device for dispensing a compound as set forth in claim 7, wherein:
the flotation element is adjustable to vary the buoyancy force of the device.

11. The device for dispensing a compound as set forth in claim 7, wherein:
the flotation element is comprised of one or more separate floatation parts that may be removed to adjust a buoyancy of the device commensurate with the amount of compound.

12. A device for dispensing a compound, comprising:
a cap;
a floatation element removably associated with the cap;
a first member, with the cap detachably associated with the first member;
a second member moveably associated with the first member;
the first and the second members define a side opening of the device that varies in size as the first and the second members move;
wherein: the compound is side loaded into the device without removing the cap through the side opening or top-loaded by removing the cap.

13. The device for dispensing a compound as set forth in claim 12, wherein:
the floatation element is friction-fit within an interior cavity of the cap.

14. The device for dispensing a compound as set forth in claim 12, wherein:
the floatation element is comprised of one or more removable floatation pieces, wherein: addition or removal a floatation piece from the one or more floatation pieces varies a buoyancy of the device to enable use of different weight compounds.

15. The device for dispensing a compound as set forth in claim 12, wherein:
the cap is comprised of:
an interior cavity that friction-fit secures the floatation element.

16. The device for dispensing a compound as set forth in claim 12, wherein:
the cap is comprised of:
a cylindrical disk cap body with a height, and semi-circumferentially projecting rims at a bottom of the cap body;

17. The device for dispensing a compound as set forth in claim 16, wherein:
a top surface of the cap body has an indicia that when at level with the water surface, indicates that the compound within the device is not depleted;
a top surface of the projecting rim has an indicia that when above the water surface and visible, indicates that the compound within the device requires replenishing.

18. The device for dispensing a compound as set forth in claim 16, wherein:
the height of the cylindrical disk cap body below water indicates that the compound within the device is not depleted; and
the height of the cylindrical disk cap body above water indicates that the compound within the device requires replenishing.

19. The device for dispensing a compound as set forth in claim 16, wherein:
a bottom surface of the projecting rim is comprised of interlocking stiffener projections that when aligned with corresponding interlocking notches on a support flange of the first member prevent cap from rotating when the cap is in a fully closed position in relation to the first member.

20. The device for dispensing a compound as set forth in claim 16, wherein:
the cap further includes:
snap joints positioned between the semi-circumferentially projecting rims;
the snap joints include lugs that detachably snap fit into respective a first and a second lateral openings of the first member.

21. The device for dispensing a compound as set forth in claim 20, wherein:
the lugs include angled interlock surface, radially protruding from outer surface of the snap joints.

22. The device for dispensing a compound as set forth in claim 20, wherein:
the lugs include angled interlock surface that interlock with angled surfaces of first sides of the a first and a second lateral openings of the first member.

23. The device for dispensing a compound as set forth in claim 12, wherein:
the first member is comprised of:
a hollow, generally cylindrical configuration with a top edge that includes a plurality of support flanges in between which are interlocking notches.

24. The device for dispensing a compound as set forth in claim 23, wherein:
the interlocking notches lead into an upper flow recess for further enhancing flow.

25. The device for dispensing a compound as set forth in claim 23, wherein:
the interlocking notches and the upper flow recesses improve flow of dissolved compound from top of the device.

26. The device for dispensing a compound as set forth in claim 12, wherein:
the first member is further comprised of a tie-down member at an exterior surface, near a top edge of the first member.

27. The device for dispensing a compound as set forth in claim 26, wherein:
the tie-down member is comprised of a first tie-down member and a second tie-down member positioned diametrically at the exterior surface, near the top edge of the first member.

28. The device for dispensing a compound as set forth in claim 12, wherein:
the first member is further comprised an interior surface that is smooth;
the interior surface of the first member includes an inner circumferential stop ledge, projecting from the interior surface.

29. The device for dispensing a compound as set forth in claim 12, wherein:
the first member further comprised of:
a first lateral opening and a second lateral opening.

30. The device for dispensing a compound as set forth in claim 29, wherein:
the first and the second lateral openings of the first member are comprised of three sides, allowing for transverse flexure of the first member;
wherein: the transverse flexure of the first member enables rotational movement of the first and the second members in relation to one another.

31. The device for dispensing a compound as set forth in claim 29, wherein:
the first and the second lateral openings of the first member provide for a 180° side loading of compound;
wherein: the second member is moved through 180° rotation to reach one of the first and the second lateral openings to define the side opening of the device for side loading of the compound.

32. The device for dispensing a compound as set forth in claim 29, wherein:
the first member is further comprised of a plurality of dampers.

33. The device for dispensing a compound as set forth in claim 32, wherein:
the dampers extend longitudinally parallel a longitudinal axis of the device.

34. The device for dispensing a compound as set forth in claim 33, wherein:
the dampers are connected laterally with damper supports.

35. The device for dispensing a compound as set forth in claim 34, wherein:
dampers have an inner concaved surface that function as an interlock relief for receiving an interlocking projection of a second member to maintain the rotational position of a second member in relation to the first member.

36. The device for dispensing a compound as set forth in claim 32, wherein:
the longitudinal extensions of the dampers differ to vary a flow rate of water into and out of the device in relation to a lateral opening of the second member.

37. The device for dispensing a compound as set forth in claim 32, wherein:
as the first and the second members rotate in relation to one another, differing sized dampers obstruct a lower portion of the lateral opening of the second member at different obstruction levels to vary a flow rate of water into and out of the device.

38. The device for dispensing a compound as set forth in claim 12, wherein:
the second member is comprised of:
a lateral opening that when aligned with one of the first and second lateral openings of the first member, defines the side opening of the device.

39. The device for dispensing a compound as set forth in claim 12, wherein:
the second member is comprised of:
an upper portion having a plurality of elongated slits oriented parallel a longitudinal axis of the device;
the plurality of elongated slits are positioned asymmetrically along the upper portion and function as mid-vents to control a rate of flow of water through the mid-portion of the device in cooperation with the plurality of dampers of the first member as the first and the second members are moved in relation to one another.

40. The device for dispensing a compound as set forth in claim 39, wherein:
the second member is further comprised of:
interlocking projections that engage dampers on the first member to maintain the position of the first and second members in relation to one another.

41. The device for dispensing a compound as set forth in claim 39, wherein:
the second member is further comprised of:
a plurality of openings that are positioned around a bottom portion of the second member, equally distanced from one another.

42. The device for dispensing a compound as set forth in claim 39, wherein:
the second member is further comprised of:
support projecting from an exterior bottom surface;
the supports raise a bottom of the second member off of a pool floor, allowing for proper current flow between the bottom of the second member and the bottom of the pool floor for dispersion of the compound as dissolved compound egresses from the bottom openings.

43. The device for dispensing a compound as set forth in claim 12, further comprising:
a holder that detachably coupled with the second member for retaining an anti-electrolysis element.
